(19) United States
(12) Patent Application Publication
(10) Pub. No.: US 2025/0187355 A1
(43) Pub. Date: Jun. 12, 2025

(54) INKJET RECORDING APPARATUS

(71) Applicant: CANON KABUSHIKI KAISHA, Tokyo (JP)

(72) Inventor: SHUICHI TAKENAKA, Chiba (JP)

(21) Appl. No.: 18/938,448

(22) Filed: Nov. 6, 2024

(30) Foreign Application Priority Data
Dec. 8, 2023 (JP) 2023-207615

(51) Int. Cl. B41J 13/00; B41J 11/00; B41J 13/10

(52) U.S. Cl. CPC B41J 13/0036; B41J 11/0095; B41J 13/106

(57) ABSTRACT

An inkjet recording apparatus controls a conveying portion such that a sheet detected by a detector passes through an ink head portion without forming an image and is discharged to a first stack tray, and controls the conveying portion such that a sheet which precedes the sheet detected by the detector, on which the image has been formed on a first side, and which is positioned on a second conveyance path to form the image on a second side passes through the ink head portion to form the image and is discharged to a second stack tray, in a case where the sheet conveyed by the conveying portion is detected by the detector.

### BACKGROUND OF THE INVENTION

### Field of the Invention

The present invention relates to an inkjet recording apparatus that forms an image on a sheet.

### Description of the Related Art

Hitherto, an inkjet type image forming apparatus that ejects ink onto a recording medium such as a sheet to print an image includes a recording head unit including an inkjet head that ejects the ink in an image forming portion. The inkjet head of the recording head unit is a precision part that requires precise control, and is disposed close to a recording side of the recording medium to execute image forming processing.

In such an inkjet type image forming apparatus, in a case where the inkjet head comes into contact with the recording medium where uplift has occurred, the inkjet head may be damaged. Therefore, the inkjet type image forming apparatus needs to remove the recording medium where the uplift has occurred without damaging the inkjet head and resume a job to perform error recovery.

Japanese Patent Application Laid-Open No. 2021-66129 discloses an inkjet recording apparatus that protects an inkjet head from a recording medium where uplift has occurred. The inkjet recording apparatus of Japanese Patent Application Laid-Open No. 2021-66129 immediately retracts an inkjet head portion from a conveyance path when the recording medium where the uplift has occurred is detected, thereby avoiding damage of the inkjet head due to contact between the recording medium where the uplift has occurred and the inkjet head. However, Japanese Patent Application Laid-Open No. 2021-66129 does not disclose how to perform error recovery by discharging the recording medium where the uplift has occurred after retracting the inkjet head.

On the other hand, Japanese Patent Application Laid-Open No. 2004-20650 discloses an error recovery method at the time of detection of an abnormal sheet. In a case where inspection processing is executed on a sheet after image formation and an abnormal sheet is detected, an image forming apparatus of Japanese Patent Application Laid-Open No. 2004-20650 stores the detected abnormal sheet in a predetermined abnormal sheet storage portion and temporarily stores a normal sheet subsequent to the abnormal sheet in a predetermined normal sheet storage portion.

Further, when the storage of each sheet is completed, the image forming apparatus of Japanese Patent Application Laid-Open No. 2004-20650 starts feeding an additional sheet from a sheet tray, and forms an image scheduled to be printed on the abnormal sheet on the fed additional sheet. Then, when image forming processing on the additional sheet is completed, the image forming apparatus of Japanese Patent Laid-Open No. 2004-20650 starts feeding the normal sheet from the normal sheet storage portion again, and performs error recovery according to an order of sheet discharge.

However, in Japanese Patent Application Laid-Open No. 2004-20650, error recovery processing is executed when an abnormality is detected for a sheet after image formation, and it is not mentioned that the error recovery processing is executed by discharging a sheet when an abnormality is detected for a sheet before image formation.

### SUMMARY OF THE INVENTION

It is desirable to provide an inkjet recording apparatus capable of reducing a downtime as compared with a case where a sheet on which an image has been formed on a first side and which is conveyed before a sheet before image formation detected by a detector is discharged and temporarily retracted by forming the image on a second side of the sheet on which the image has been formed on the first side and which is conveyed before the sheet before image formation detected by the detector.

An inkjet recording apparatus according to the present invention includes: a conveying portion configured to convey a sheet; an ink head portion configured to eject ink onto the sheet conveyed by the conveying portion to form an image; a detector provided upstream of the ink head portion in a conveyance direction of the sheet and configured to detect the sheet conveyed by the conveying portion; a first stack tray provided downstream of the ink head portion in the conveyance direction and on which the sheet conveyed by the conveying portion is stacked; a first conveyance path provided upstream of the first stack tray in the conveyance direction and through which the sheet conveyed by the conveying portion passes; a second stack tray provided downstream of the ink head portion in the conveyance direction and on which the sheet conveyed by the conveying portion is stacked; a second conveyance path branched from a portion of the first conveyance path that is downstream of the ink head portion and upstream of the first stack tray in the conveyance direction and through which the sheet on which the image has been formed on a first side by the ink head portion passes by being conveyed by the conveying portion to form the image on a second side opposite to the first side; and a controller configured to control the conveying portion such that the sheet detected by the detector passes through the ink head portion without forming the image and is discharged to the first stack tray, and control the conveying portion such that a sheet which precedes the sheet detected by the detector, on which the image has been formed on the first side, and which is positioned on the second conveyance path to form the image on the second side passes through the ink head portion to form the image and is discharged to the second stack tray, in a case where the sheet conveyed by the conveying portion is detected by the detector.

Further features of the present invention will become apparent from the following description of exemplary embodiments with reference to the attached drawings.

### BRIEF DESCRIPTION OF THE DRAWINGS

FIGS. 1A and 1B are a schematic view and a diagram of an image forming apparatus according to a first embodiment of the present invention;

FIGS. 2A to 2C are schematic views of a printing portion of the image forming apparatus according to the first embodiment of the present invention;

FIG. 3 is a block diagram illustrating a hardware configuration of the image forming apparatus according to the first embodiment of the present invention;

FIG. 4 is a schematic diagram illustrating a configuration of a software module of the image forming apparatus according to the first embodiment of the present invention;

FIG. 5 is a schematic view of a state of the image forming apparatus according to the first embodiment of the present invention immediately before a misfed sheet on which an image has not been printed is detected;

FIG. 6 is a schematic view of a state of the image forming apparatus according to the first embodiment of the present invention immediately after the misfed sheet on which the image has not been printed is detected;

FIG. 7 is a schematic view of a state of the image forming apparatus according to the first embodiment of the present invention in which the misfed sheet on which the image has not been printed and some of subsequent sheets are discharged to sheet discharge destinations;

FIG. 8 is a schematic view of a state of the image forming apparatus according to the first embodiment of the present invention in which all sheets including the misfed sheet on which the image has not been printed are discharged to the sheet discharge destinations;

FIG. 9 is a schematic view of a state of the image forming apparatus according to the first embodiment of the present invention immediately before the misfed sheet on which the image has been printed only on a front side is detected;

FIG. 10 is a schematic view of a state of the image forming apparatus according to the first embodiment of the present invention in which the misfed sheet on which the image has been printed only on the front side and some of the subsequent sheets are discharged to the sheet discharge destinations;

FIG. 11 is a schematic view illustrating a state of the image forming apparatus according to the first embodiment of the present invention in which all the sheets including the misfed sheet on which the image has been printed only on the front side are discharged to the sheet discharge destinations;

FIG. 12 is a diagram illustrating an example of a sheet discharge destination management table used by the image forming apparatus according to the first embodiment of the present invention;

FIG. 13 is a sequence diagram illustrating an operation based on the software module of the image forming apparatus according to the first embodiment of the present invention;

FIG. 14 is a flowchart illustrating an operation of hardware of the image forming apparatus according to the first embodiment of the present invention;

FIG. 15 is a flowchart illustrating a procedure of misfed sheet detection control processing executed by the image forming apparatus according to the first embodiment of the present invention;

FIG. 16 is a flowchart illustrating a procedure of print head control processing executed by the image forming apparatus according to the first embodiment of the present invention;

FIG. 17 is a flowchart illustrating a procedure of print head retraction processing executed by the image forming apparatus according to the first embodiment of the present invention;

FIG. 18 is a flowchart illustrating a procedure of sheet conveyance control processing executed by the image forming apparatus according to the first embodiment of the present invention;

FIG. 19 is a flowchart illustrating a procedure of remaining sheet detection control processing executed by the image forming apparatus according to the first embodiment of the present invention;

FIG. 20 is a flowchart illustrating a procedure of conveyance rerouting control processing executed by the image forming apparatus according to the first embodiment of the present invention; and

FIG. 21 is a flowchart illustrating a procedure of conveyance rerouting control processing executed by an image forming apparatus according to a second embodiment of the present invention.

### DESCRIPTION OF THE EMBODIMENTS

Hereinafter, embodiments will be described in detail with reference to the drawings.

### First Embodiment

### <Configuration of Image Forming Apparatus

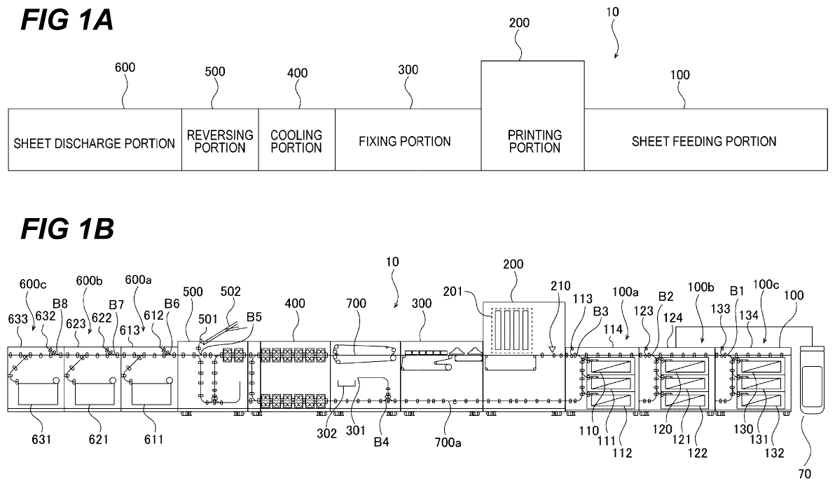

A configuration of an image forming apparatus 10 according to a first embodiment of the present invention will be described in detail with reference to FIGS. 1A to 3.

Here, the image forming apparatus 10 as an inkjet recording apparatus is exemplified by a large commercial printer including a plurality of sheet discharge ports. A print server 70 is connected to the image forming apparatus 10. The image forming apparatus 10 starts a printing operation by receiving a print job transmitted from the print server 70. Here, the print server 70 can confirm a state of the image forming apparatus 10, monitor the print job, and perform maintenance control, and can execute various functions of the image forming apparatus 10 by comprehensively operating the image forming apparatus 10. Further, printing means forming an image.

Specifically, the image forming apparatus 10 includes a sheet feeding portion 100, a printing portion 200, a fixing portion 300, a cooling portion 400, a reversing portion 500, a sheet discharge portion 600, a conveying portion 700, a first conveyance path 700a, a second conveyance path 700b, a controller unit 1000, and a printer engine 1009.

The sheet feeding portion 100 is a unit that holds a sheet and feeds the held sheet to the printing portion 200. The sheet feeding portion 100 includes a first stage sheet feeding portion 100a, a second stage sheet feeding portion 100b, and a third stage sheet feeding portion 100c. The sheet feeding portion 100 has a configuration in which three sheet feeding portions of the first stage sheet feeding portion 100a, the second stage sheet feeding portion 100b, and the third stage sheet feeding portion 100c having the same configuration are continuously connected.

The first stage sheet feeding portion 100a includes a sheet feeding cassette 110, a sheet feeding cassette 111, a sheet feeding cassette 112, a sheet discharge port 113, and a sheet feeding portion 1TOP tray 114.

The sheet feeding cassette 110 is the uppermost sheet feeding cassette, and holds various printing sheets used for printing processing.

The sheet feeding cassette 111 is the middle sheet feeding cassette disposed between the sheet feeding cassette 110 and the sheet feeding cassette 112, and holds various printing sheets used for the printing processing.

The sheet feeding cassette 112 is the lowermost sheet feeding cassette, and holds various printing sheets used for the printing processing.

The sheet discharge port 113 is provided to discharge and retract the sheet conveyed by the conveying portion 700 to the sheet feeding portion 1TOP tray 114. The sheet discharge port 113 is provided at a distal end of a branch conveying portion branched from a branch position B3 of the conveying portion 700.

The sheet feeding portion 1TOP tray 114 as a third stack tray is provided upstream of an optical sensor 210 described below of the printing portion 200 in a conveyance direction of the sheet (hereinafter, simply referred to as “conveyance direction”). The sheet discharged through the sheet discharge port 113 is stacked on the sheet feeding portion 1TOP tray 114.

The second stage sheet feeding portion 100b includes a sheet feeding cassette 120, a sheet feeding cassette 121, a sheet feeding cassette 122, a sheet discharge port 123, and a sheet feeding portion 2TOP tray 124.

The sheet feeding cassette 120 is the uppermost sheet feeding cassette, and holds various printing sheets used for the printing processing.

The sheet feeding cassette 121 is the middle sheet feeding cassette disposed between the sheet feeding cassette 120 and the sheet feeding cassette 122, and holds various printing sheets used for the printing processing.

The sheet feeding cassette 122 is the lowermost sheet feeding cassette, and holds various printing sheets used for the printing processing.

The sheet discharge port 123 is provided to discharge and retract the sheet conveyed by the conveying portion 700 to the sheet feeding portion 2TOP tray 124. The sheet discharge port 123 is provided at a distal end of a branch conveying portion branched from a branch position B2 of the conveying portion 700.

The sheet feeding portion 2TOP tray 124 as the third stack tray is provided upstream of the optical sensor 210 of the printing portion 200 in the conveyance direction. The sheet discharged through the sheet discharge port 123 is stacked on the sheet feeding portion 2TOP tray 124.

The third stage sheet feeding portion 100c includes a sheet feeding cassette 130, a sheet feeding cassette 131, a sheet feeding cassette 132, a sheet discharge port 133, and a sheet feeding portion 3TOP tray 134.

The sheet feeding cassette 130 is the uppermost sheet feeding cassette, and holds various printing sheets used for the printing processing.

The sheet feeding cassette 131 is the middle sheet feeding cassette disposed between the sheet feeding cassette 130 and the sheet feeding cassette 132, and holds various printing sheets used for the printing processing.

The sheet feeding cassette 132 is the lowermost sheet feeding cassette, and holds various printing sheets used for the printing processing.

The sheet discharge port 133 is provided to discharge and retract the sheet conveyed by the conveying portion 700 to the sheet feeding portion 3TOP tray 134. The sheet discharge port 133 is provided at a distal end of a branch conveying portion branched from a branch position B1 of the conveying portion 700.

The sheet feeding portion 3TOP tray 134 as the third stack tray is provided upstream of the optical sensor 210 of the printing portion 200 in the conveyance direction. The sheet discharged through the sheet discharge port 133 is stacked on the sheet feeding portion 3TOP tray 134.

The printing portion 200 is a unit that performs an image forming operation of printing the image on both of a front side as a first side and a back side as a second side of the sheet conveyed by the conveying portion 700. In single-sided printing in which the image is printed only on the front side, the printing portion 200 prints the image on the front side of the sheet which is fed from the sheet feeding portion 100 and of which the front side and the back side are both blank. In double-sided printing in which the image is printed on both of the front side and the back side, the printing portion 200 prints the image on the front side of the sheet which is fed from the sheet feeding portion 100 and of which both sides are blank. In the double-sided printing, the printing portion 200 prints the image on the back side of the sheet which is conveyed by the conveying portion 700 from the sheet feeding portion 100 and on which the image has been printed only on the front side. The printing portion 200 includes the inkjet head 201 and the optical sensor 210.

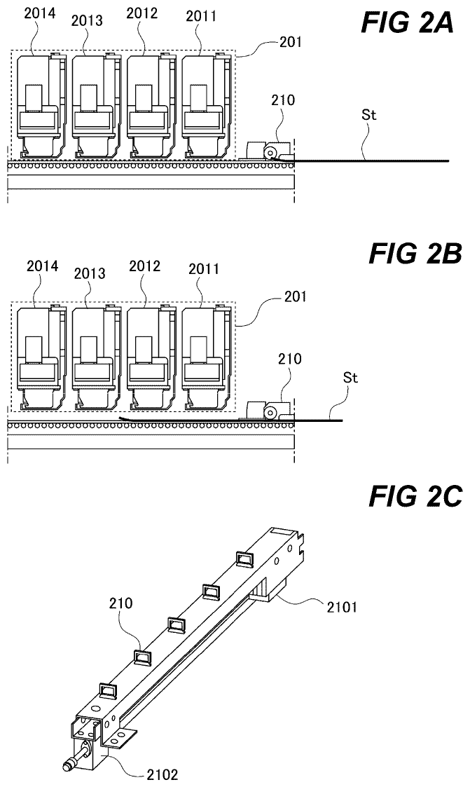

The inkjet head 201 as an ink head portion is movable between the printing position illustrated in FIG. 2A and the retraction position illustrated in FIG. 2B under the control of a head controller 1010. Here, the printing position is a position where the image is printed by approaching the sheet conveyed by the conveying portion 700 and ejecting ink. In addition, the retraction position is a position separated from the sheet conveyed by the conveying portion 700 in order to avoid contact with a misfed sheet as an abnormal sheet where an abnormality such as a corner fold at an edge portion or uplift has occurred (hereinafter, simply referred to as “misfed sheet”). The retraction position is a position farther from the sheet than the printing position.

The inkjet head 201 includes a plurality of recording heads 2011, 2012, 2013, and 2014.

The recording head 2011, the recording head 2012, the recording head 2013, and the recording head 2014 are line type recording heads using an inkjet method and arranged in the conveyance direction of the sheet (hereinafter, simply referred to as “conveyance direction”). A method using a heat generating element, a method using a piezoelectric element, a method using an electrostatic element, a method using a MEMS element, or the like can be adopted as the inkjet method. Ink of each color is supplied from an ink reservoir to each of the recording head 2011, the recording head 2012, the recording head 2013, and the recording head 2014 via an ink tube.

The recording head 2011, the recording head 2012, the recording head 2013, and the recording head 2014 are recording heads of four colors of Bk (black), Y (yellow), M (magenta), and C (cyan), respectively. The number of colors and the number of recording heads of the inkjet head 201 are not limited to four colors and four and may be any number of colors and any number. For example, the number of colors may be one, and the number of recording heads may be one.

The optical sensor 210 as a detector detects the abnormality such as a corner fold at an edge portion or uplift of the sheet conveyed by the conveying portion 700, and outputs an electric signal corresponding to a detection result to the controller unit 1000. The optical sensor 210 is provided upstream of the inkjet head 201 in the conveyance direction, and detects the misfed sheet before the image is printed by the inkjet head 201.

Specifically, the optical sensor 210 includes a light projecting portion 2101 and a light receiving portion 2102.

The light projecting portion 2101 emits a laser toward the light receiving portion 2102.

The light receiving portion 2102 includes a light receiving element (CCD). The light receiving portion 2102 enters a light receiving state in which the laser emitted from the light projecting portion 2101 is received by the light receiving element or a light blocked state in which the laser cannot be received by the light receiving element because the laser is blocked by a blocking object interposed between the light receiving element and the light projecting portion 2101. The blocking object is the corner fold of the misfed sheet, the uplift of the misfed sheet, or the like.

In a case where the light receiving element of the light receiving portion 2102 is in the light blocked state because there is a blocking object between the light projecting portion 2101 and the light receiving portion 2102, a bright portion (light incident portion) that receives the laser from the light projecting portion 2101 and a dark portion (light blocked portion) that corresponds to a shadow of the blocking object are generated. The light receiving portion 2102 outputs an electric signal corresponding to a light receiving quantity of the laser in the light receiving state or the light blocked state of the light receiving element to the controller unit 1000 via the printer engine 1009.

The fixing portion 300 is a unit that performs fixing control of fixing the image printed on the sheet to the sheet by using a plurality of heater units for the sheet which is conveyed by the conveying portion 700 and on which the image has been printed in the printing portion 200. The fixing portion 300 includes a sheet discharge port 301.

The sheet discharge port 301 is provided to discharge and retract the sheet conveyed by the conveying portion 700 to a fixing portion double-sided tray. The sheet discharge port 301 is provided at a distal end of a branch conveying portion branched from a branch position B4 of the conveying portion 700.

The cooling portion 400 is a unit that performs temperature control of cooling the sheet which is conveyed by the conveying portion 700 and on which the image is fixed in the fixing portion 300 to normal temperature by using a plurality of fan units.

The reversing portion 500 performs switchback conveyance of the sheet cooled in the cooling portion 400 and conveyed by the conveying portion 700. The reversing portion 500 reverses the front side and the back side of the sheet such that the back side of the sheet printed on both of the front side and the back side is changed from an upper side to a lower side by performing switchback conveyance of the sheet. The reversing portion 500 includes a sheet discharge port 501.

The sheet discharge port 501 is provided to discharge and retract the sheet conveyed by the conveying portion 700 to the reversing portion TOP tray 502. The sheet discharge port 501 is provided at a distal end of a branch conveying portion branched from a branch position B5 of the conveying portion 700.

The sheet discharged from the sheet discharge port 501 is stacked on the reversing portion TOP tray 502 as a first stack tray.

The sheet discharge portion 600 is a unit that performs control to stack and discharge the sheet conveyed by the conveying portion 700 from the reversing portion 500. The sheet discharge portion 600 has a configuration in which three units of the same sheet discharge portions of a first stage sheet discharge portion 600a, a second stage sheet discharge portion 600b, and a third stage sheet discharge portion 600c are continuously connected.

The first stage sheet discharge portion 600a includes a discharged sheet stacker 611 and a sheet discharge port 612.

The sheet on which the image has been printed on both sides and which is discharged by the conveying portion 700 is stacked on the discharged sheet stacker 611.

The sheet discharge port 612 is provided to discharge and retract the sheet conveyed by the conveying portion 700 to a sheet discharge portion 1TOP tray. The sheet discharge port 612 is provided at a distal end of a branch conveying portion branched from a branch position B6 of the conveying portion 700.

The second stage sheet discharge portion 600b includes a discharged sheet stacker 621 and a sheet discharge port 622.

The sheet on which the image has been printed on both sides and which is discharged by the conveying portion 700 is stacked on the discharged sheet stacker 621.

The sheet discharge port 622 is provided to discharge and retract the sheet conveyed by the conveying portion 700 to a sheet discharge portion 2TOP tray. The sheet discharge port 622 is provided at a distal end of a branch conveying portion branched from a branch position B7 of the conveying portion 700.

The third stage sheet discharge portion 600c includes a discharged sheet stacker 631 and a sheet discharge port 612.

The sheet on which the image has been printed on both sides and which is discharged by the conveying portion 700 is stacked on the discharged sheet stacker 631.

The sheet discharge port 632 is provided to discharge and retract the sheet conveyed by the conveying portion 700 to a sheet discharge portion 3TOP tray. The sheet discharge port 632 is provided at a distal end of a branch conveying portion branched from a branch position B8 of the conveying portion 700.

During the single-sided printing, the conveying portion 700 conveys the sheet fed from the sheet feeding portion 100 in the order of the printing portion 200, the fixing portion 300, the cooling portion 400, the reversing portion 500, and the sheet discharge portion 600. During the double-sided printing, the conveying portion 700 conveys the sheet fed from the sheet feeding portion 100 in the order of the printing portion 200, the fixing portion 300, and the cooling portion 400. Thereafter, the conveying portion 700 conveys the sheet in the order of the cooling portion 400, the fixing portion 300, the printing portion 200, the sheet feeding portion 100, the printing portion 200, the fixing portion 300, the cooling portion 400, the reversing portion 500, and the sheet discharge portion 600.

The conveying portion 700 performs sheet discharge to the sheet feeding portion 1TOP tray 114, the sheet feeding portion 2TOP tray 124, the sheet feeding portion 3TOP tray 134, or the fixing portion double-sided tray through the sheet discharge port 113, 123, 133, or 301. Alternatively, the conveying portion 700 performs sheet discharge to the reversing portion TOP tray 502, the sheet discharge portion 1TOP tray, the sheet discharge portion 2TOP tray, or the sheet discharge portion 3TOP tray through the sheet discharge port 501, 612, 622, or 623.

The first conveyance path 700a is provided upstream of the reversing portion TOP tray 502 in the conveyance direction.

The second conveyance path 700b is a conveyance path which is branched from a portion of the first conveyance path 700a that is downstream of the inkjet head 201 and upstream of the reversing portion TOP tray 502 in the conveyance direction, and through which the sheet on which the image has been formed on the front side by the inkjet head 201 passes to form the image on the back side opposite to the front side.

The controller unit 1000 is connected to an external device via the printer engine 1009 and a local area network 1007. The controller unit 1000 comprehensively controls an operation of the image forming apparatus 10, and performs input/output control of device information and a sensor signal with the printer engine 1009 and an external device.

The controller unit 1000 is not limited to be configured as one unit, and may be provided in each of the sheet feeding portion 100, the printing portion 200, the fixing portion 300, the cooling portion 400, the reversing portion 500, and the sheet discharge portion 600. In a case where the controller unit 1000 is provided in each of the sheet feeding portion 100, the printing portion 200, the fixing portion 300, the cooling portion 400, the reversing portion 500, and the sheet discharge portion 600, a specific controller unit 1000 comprehensively controls the other controller units 1000.

The controller unit 1000 includes a central processing unit (CPU) 1001, a random access memory (RAM) 1002, a read only memory (ROM) 1003, a hard disk drive (HDD) 1004, a network interface (I/F) 1006, a device I/F 1008, a head controller 1010, and a conveyance controller 1011.

The CPU 1001 reads a program stored in the ROM 1003 or the HDD 1004, stores the program in the RAM 1002, and executes the program stored in the RAM 1002 to control the operation of the image forming apparatus 10.

The CPU 1001 executes the program stored in the RAM 1002 to comprehensively control each device connected via a system bus 1005. When the image forming apparatus 10 is powered on, the CPU 1001 performs predetermined control by reading and executing the program stored in the ROM 1003. The CPU 1001 installs the program received by the network I/F 1006 in the ROM 1003 or the HDD 1004. The CPU 1001 transmits data or device information generated in the control of the operation of the image forming apparatus 10 to an external device via the network I/F 1006 and the local area network 1007.

The CPU 1001 acquires image data transferred from the print server 70 via the local area network 1007 and the network I/F 1006. The CPU 1001 drives each device of the printer engine 1009 via the device I/F 1008 based on the acquired image data to print the image on the sheet.

The CPU 1001 controls the head controller 1010 and the conveyance controller 1011 based on an electric signal input from the optical sensor 210 via the printer engine 1009 and the device I/F 1008.

Specifically, the CPU 1001 executes misfed sheet detection control processing described below to detect the misfed sheet based on an electric signal corresponding to the light receiving state or the light blocked state in the light receiving element of the light receiving portion 2102 input from the optical sensor 210. For example, the CPU 1001 determines a portion where the light receiving quantity of the light receiving portion 2102 indicated by the electric signal input from the light receiving portion 2102 is less than a reference as the light blocked portion, and detects the misfed sheet that is the blocking object in a case where the light blocked portion occupies a predetermined ratio or more.

When the misfed sheet is detected, the CPU 1001 executes print head control processing described below to control the head controller 1010 to move and retract the inkjet head 201 from the printing position to the retraction position. When the misfed sheet is detected, the CPU 1001 executes sheet conveyance control processing described below to control the conveyance controller 1011 to discharge and temporarily retracts the sheet (hereinafter, referred to as “subsequent sheet”) conveyed after the abnormal sheet to a predetermined sheet discharge destination. The CPU 1001 prints the image on the sheet (hereinafter, referred to as “preceding sheet”) conveyed before the abnormal sheet or discharges the sheet to the predetermined sheet discharge destination without printing the image, according to a printing state of the abnormal sheet.

When the misfed sheet is detected, the CPU 1001 executes remaining sheet detection processing described below to discharge the misfed sheet and the subsequent sheet, and then check whether or not there is a sheet remaining on a conveyance path.

The CPU 1001 is not limited to be provided in the controller unit 1000, and may be provided in a controller unit present in each of the sheet feeding portion 100, the printing portion 200, the fixing portion 300, the cooling portion 400, the reversing portion 500, and the sheet discharge portion 600.

The RAM 1002 functions as a main memory or a work memory of the CPU 1001. The RAM 1002 stores the program read from the ROM 1003 or the HDD 1004 by the CPU 1001.

The ROM 1003 stores various programs such as a control program and a boot program, and various tables including a sheet discharge destination management table described below.

The HDD 1004 stores various programs including an operating system (OS) program. The HDD 1004 is also used for the purpose of temporarily or long-term holding a large amount of data. The program stored in the HDD 1004 is described below.

The network I/F 1006 is an interface unit with the local area network 1007, and is connected to the local area network 1007. The network I/F 1006 receives data, device information, or a program from an external device via the local area network 1007, and outputs the received data, device information, or program to the CPU 1001. The network I/F 1006 transmits data or device information output from the CPU 1001 to an external device via the local area network 1007.

The device I/F 1008 is an interface unit with the printer engine 1009, and is connected to the printer engine 1009. The device I/F 1008 inputs and outputs signals for operating and referring to various motors, sensors, the inkjet head 201, and the like between the CPU 1001 and the printer engine 1009.

The head controller 1010 controls an operation of the inkjet head 201 included in the printer engine 1009 via the device I/F 1008 under the control of the CPU 1001.

The conveyance controller 1011 controls an operation of feeding the sheet from the sheet feeding portion 100 under the control of the CPU 1001. The conveyance controller 1011 controls an operation of a conveyance motor under the control of the CPU 1001 in order to convey the sheet by the conveying portion 700 and discharge the sheet to the sheet discharge portion 600 in synchronization with an ink discharge timing of the inkjet head 201. The conveyance controller 1011 controls sensors including the optical sensor 210 under the control of the CPU 1001. The conveyance controller 1011 controls the operation of the conveyance motor under the control of the CPU 1001 to discharge and temporarily retract the sheet being conveyed to the predetermined sheet discharge destination when the misfed sheet is detected.

The printer engine 1009 includes the inkjet head 201 and the like. The optical sensor 210, various motors, and the like are connected to the printer engine 1009. The printer engine 1009 is an inkjet type output device that conveys the sheet under the control of the controller unit 1000 and prints the image on the sheet by the inkjet head 201.

### <Configuration of Software Module Included in Image Forming Apparatus>

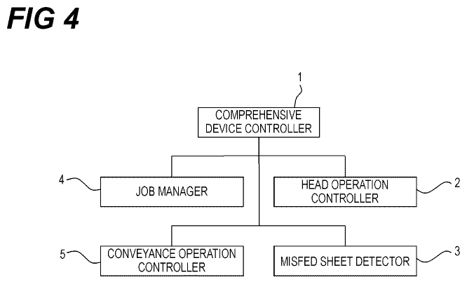

A configuration of a software module included in the image forming apparatus 10 according to the first embodiment of the present invention will be described in detail with reference to FIG. 4.

The image forming apparatus 10 includes the software module including a comprehensive device controller 1, a head operation controller 2, a misfed sheet detector 3, a job manager 4, and a conveyance operation controller 5. The software module is stored in the HDD 1004 as a program.

The comprehensive device controller 1 comprehensively controls execution of the sheet conveyance control processing, control processing for the sensors including the optical sensor 210, the print head control processing, job control processing, and the like.

The head operation controller 2 controls an operation related to the inkjet head 201. The operation related to the inkjet head 201 includes an operation of ejecting the ink onto the sheet, an operation of moving the inkjet head 201 to the retraction position when the misfed sheet is detected, an operation of moving the inkjet head 201 to the printing position after error recovery processing, and the like. Here, the error recovery processing is processing of retracting the print job being executed when the misfed sheet is detected and discharging the misfed sheet and the subsequent sheet to the predetermined sheet discharge destination to prepare for the retracted print job to be re-input.

The misfed sheet detector 3 controls the optical sensor 210 to monitor a state of the sheet conveyed during the print job, and immediately notifies the comprehensive device controller 1 of detection of the misfed sheet.

The job manager 4 performs scheduling for the print job and temporary retraction control for print job data at the time of the error recovery processing. The job manager 4 performs re-generation control for the print job data for arranging a page order of the sheets and re-scheduling after the error recovery processing.

The conveyance operation controller 5 controls conveyance of the sheet for the print job, discharge of the misfed sheet to the sheet discharge destination, retraction of the sheet being conveyed to the sheet discharge destination when the misfed sheet is detected, and re-conveyance of the sheet for a recovery job.

### <Operation of Image Forming Apparatus When Abnormality of Sheet Whose Both Sides are Blank is Detected>

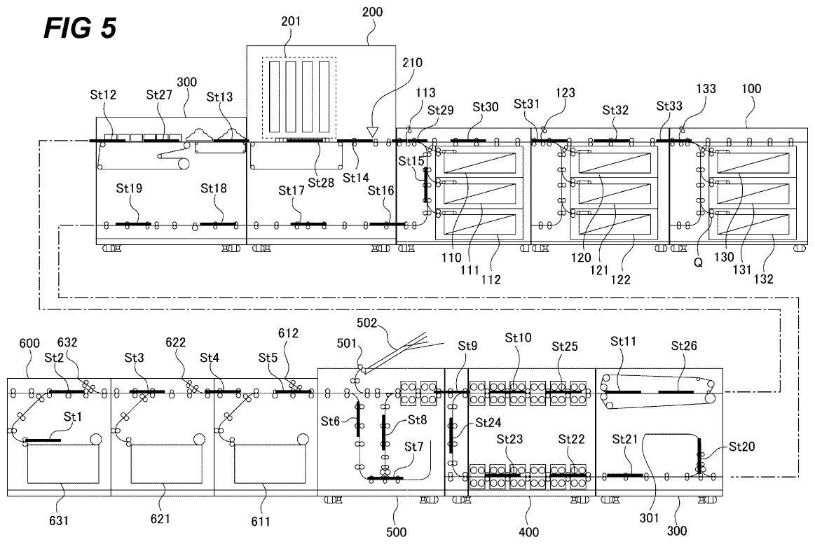

An operation of the image forming apparatus 10 according to the first embodiment of the present invention when the abnormality of the sheet whose both sides are blank is detected will be described in detail with reference to FIGS. 5 to 8.

When the abnormality of the sheet whose both sides on which the image has not been printed are blank, the image forming apparatus 10 moves the inkjet head 201 to the retraction position and discharges, to different sheet discharge destinations, the misfed sheet of which the abnormality is detected and the subsequent sheet which is a normal sheet whose both sides are blank.

Furthermore, the image forming apparatus 10 moves the inkjet head 201 to the printing position after discharging and retracting the misfed sheet, and continues conveyance of the subsequent sheet which is the normal sheet on which the image has been printed only on the front side and which has already passed through the printing portion 200 once. Then, by continuing the conveyance of the subsequent sheet, the image forming apparatus 10 prints the image also on the back side of the subsequent sheet and discharges the subsequent sheet on which the image has been printed also on the back side to a normal sheet discharge destination. As described above, the image forming apparatus 10 does not stop the conveyance of the normal sheet which has already passed through the printing portion 200 once and on which the image has been printed only on the front side, so that the normal sheet which has already passed through the printing portion 200 and on which the image has been printed only on the front side is not jammed.

As a result, it is possible to reduce a downtime for the return processing as compared with a case where the subsequent sheet on which the image has been printed only on the front side is discharged to the sheet discharge destination different from that of the misfed sheet and the conveyance is stopped to prepare for the error recovery processing. For example, in a case where the subsequent sheet on which the image has been printed only on the front side is discharged and the conveyance is stopped, it is necessary to manually arrange the discharged subsequent sheet in the sheet feeding portion 100 again. On the other hand, in the present embodiment, such manual work can be made unnecessary, and thus, the downtime for the return processing can be shortened.

FIGS. 5 to 8 illustrate, as an example, a state in which 33 sheets from St1 to St33 are conveyed into the image forming apparatus 10.

Here, in FIG. 5, St1 has reached the discharged sheet stacker 631. In addition, St29 is the misfed sheet whose both sides on which the image has not been printed are blank, and is at a position immediately before being detected as the misfed sheet by the optical sensor 210. Further, St30 to St33 being conveyed, which are the subsequent sheets following St29, are the normal sheets on which the corner fold at an edge portion and the uplift have not occurred and of which both sides are blank. Further, St15 to St28 being conveyed, which are the preceding sheets preceding St29, are the normal sheets on which the image has been printed only on the front side. Further, St15 to St28 which are the preceding sheets and St30 to St33 which are the subsequent sheets do not include the sheets on which the image has been printed on both sides.

In a case where St29 is detected as the misfed sheet, the image forming apparatus 10 immediately retracts the inkjet head 201 from the printing position to the retraction position, continues conveyance of St29, and waits for St29 to pass through the printing portion 200.

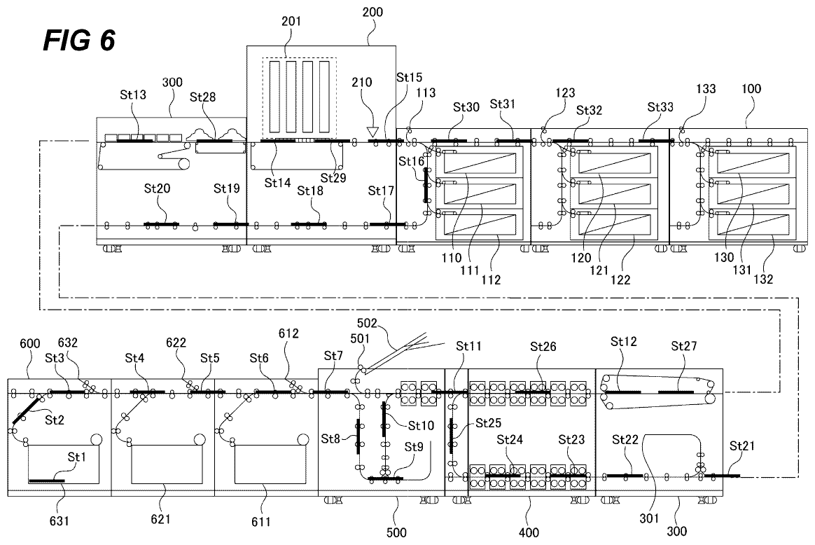

As illustrated in FIG. 6, the image forming apparatus 10 returns the inkjet head 201 from the retraction position to the printing position after St29 passes through the printing portion 200. Then, the image forming apparatus 10 continues conveyance of the sheets after St15 being conveyed, which is the preceding sheet.

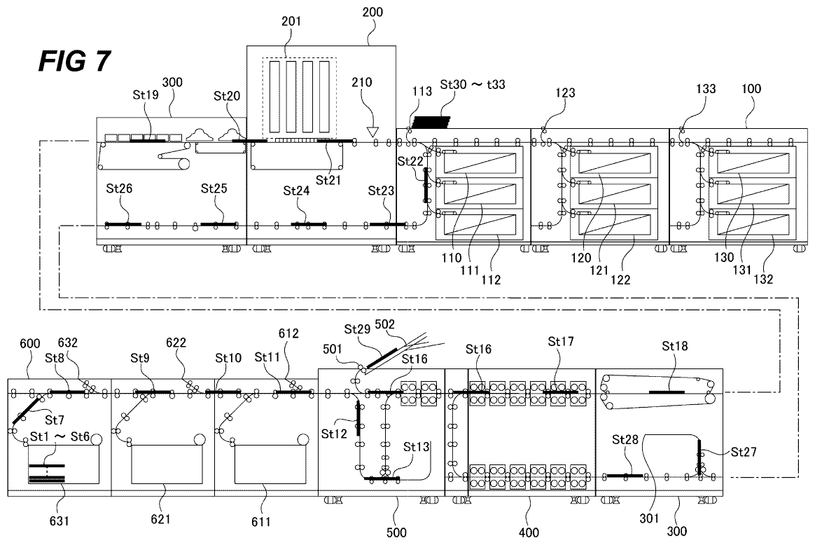

As illustrated in FIG. 7, the image forming apparatus 10 discharges and retracts St29 through the sheet discharge port 501. In addition, the image forming apparatus 10 discharges St29 to St30 of which both sides on which the image has not been printed are blank and which is present upstream of St33 in the conveyance direction through the sheet discharge port 113 corresponding to a position when the misfed sheet is detected, and discharges St29 to St30 to the sheet discharge destination different from the sheet discharge destination of St29.

On the other hand, the image forming apparatus 10 prints the image on both sides of St1 to St28, which are the normal sheets being conveyed, and then discharges St1 to St28 to the discharged sheet stacker 611 which is the normal sheet discharge destination.

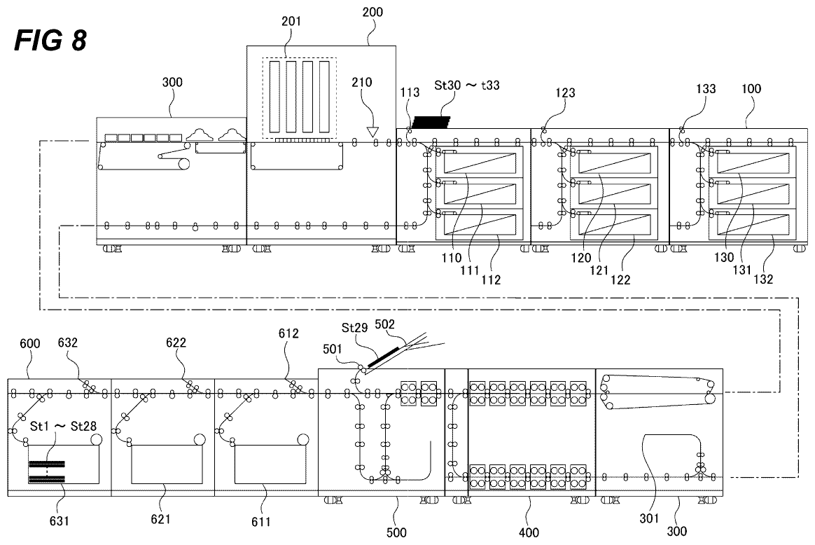

As a result, as illustrated in FIG. 8, St29, which is the misfed sheet, is discharged through the sheet discharge port 501, and St30 to St33, which are the normal sheets whose both sides on which the image has not been printed are blank, are discharged through the sheet discharge port 113. In addition, St1 to St28, which are the normal sheets on which the image has been printed on both sides are discharged to the discharged sheet stacker 611 to prepare for error recovery control.

The present invention is not limited to the case of discharging St30 to St33 whose both sides are blank as described above, and the image forming apparatus 10 may discharge St30 to St33 on which the image has been printed on both sides to the discharged sheet stacker 611 after printing the image on both sides of St30 to St33. In this case, only St29 is discharged through the sheet discharge port 501, and the print job can end without performing additional error recovery control.

### <Operation of Image Forming Apparatus When Abnormality of Sheet is Detected Immediately Before Image is Printed on Both Sides>

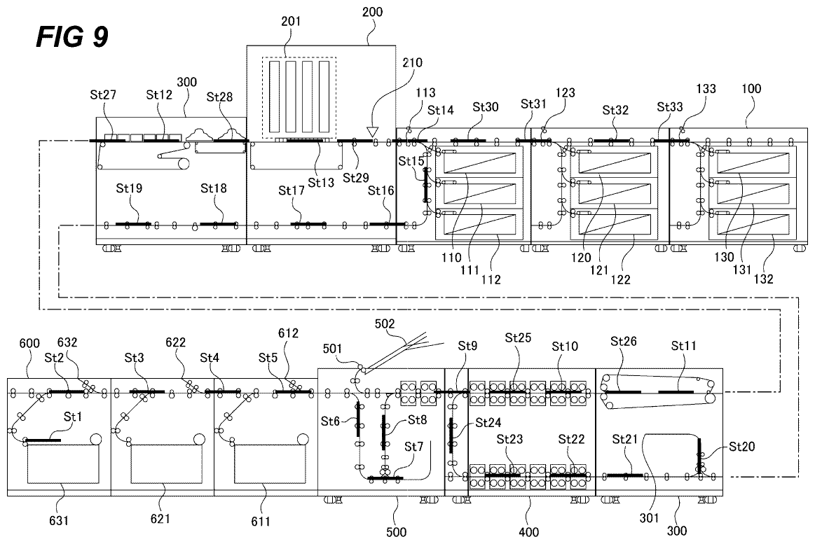

An operation of the image forming apparatus 10 according to the first embodiment of the present invention when the abnormality of the sheet is detected immediately before the image is printed on both sides will be described in detail with reference to FIGS. 9 to 11.

When the abnormality of the sheet is detected immediately before the image is printed on both sides, the image forming apparatus 10 moves the inkjet head 201 to the retraction position, and discharges each of the misfed sheet of which the abnormality is detected, the subsequent sheet which is the normal sheet, and the preceding sheet which is the normal sheet to different sheet discharge destinations.

At this time, the image forming apparatus 10 needs to execute printing processing so as to print the image printed only on the front side of the misfed sheet to another normal sheet, and also needs to arrange the image printed on another normal sheet according to the page order. Therefore, in a case where the misfed sheet is detected immediately before the image is printed on both sides, the image forming apparatus 10 temporarily retracts all the sheets being conveyed to the sheet discharge destination according to the printing state without printing the image on the normal sheet being conveyed. Further, the image forming apparatus 10 prepares for the error recovery control while maintaining the inkjet head 201 retracted to the retraction position.

FIGS. 9 to 11 illustrate, as an example, a state in which 33 sheets from St1 to St33 are conveyed into the image forming apparatus 10.

Here, in FIG. 9, St1 has reached the discharged sheet stacker 631. In addition, St14 is the misfed sheet on which the image has been printed only on the front side, St14 being at a position immediately before being detected as the misfed sheet by the optical sensor 210. Further, St30 to St33 being conveyed, which are the subsequent sheets, are the normal sheets on which the corner fold at an edge portion and the uplift have not occurred and of which both sides are blank. Further, St15 to St29 being conveyed, which are the subsequent sheets, are the normal sheets on which the image has been printed only on the front side.

In a case where St14 is detected as the misfed sheet, the image forming apparatus 10 immediately retracts the inkjet head 201 from the printing position to the retraction position.

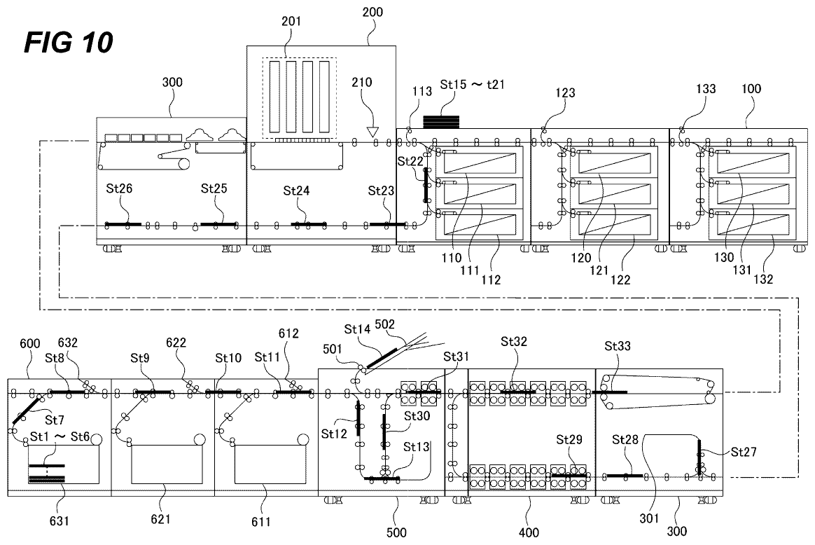

After St14 passes through the printing portion 200, the image forming apparatus 10 discharges and retracts St14 through the sheet discharge port 501 as illustrated in FIG. 10. In addition, the image forming apparatus 10 conveys St1 to St13 on which the image has been printed on both sides and which are being conveyed downstream of St14 in the conveyance direction as they are, and discharges St1 to St13 to the discharged sheet stacker 631.

In addition, the image forming apparatus 10 discharges St15 to St29 on which the image has been printed only on the front side and which are being conveyed upstream of St29 in the conveyance direction to the sheet discharge destination different from the sheet discharge destination of St14 so as to be reused by the error recovery control. Therefore, the image forming apparatus 10 discharges St15 to St29 through the sheet discharge port 113 and discharges St15 to St29 to the closest downstream sheet discharge destination in the conveyance direction when the misfed sheet is detected.

Further, the image forming apparatus 10 discharges St30 to St33, which are the normal sheets which have never passed through the printing portion 200 and of which both sides are blank, through the sheet discharge port 612, and discharges St14 to the sheet discharge destination different from the sheet discharge destination of St29.

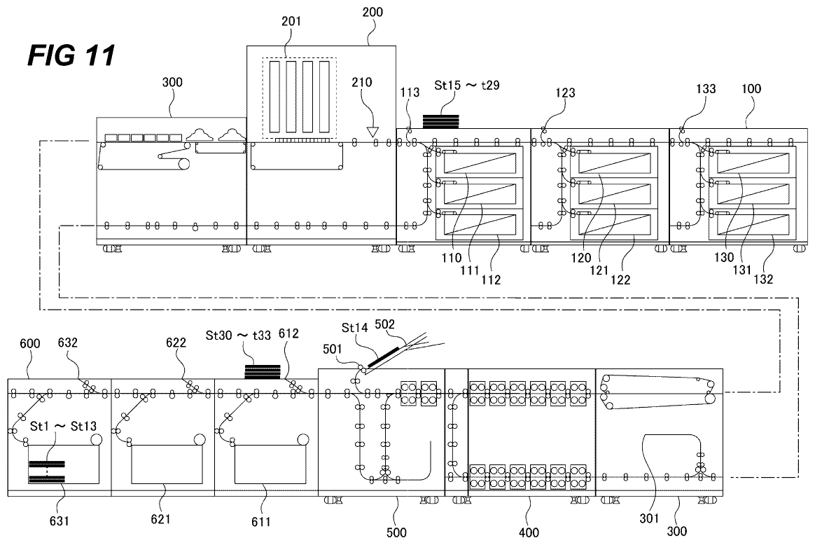

As a result, as illustrated in FIG. 11, St14, which is the misfed sheet, is discharged through the sheet discharge port 501, and St30 to St33, which are the normal sheets whose both sides are blank, are discharged through the sheet discharge port 612. Further, St15 to St29, which are the normal sheets on which the image has been printed only on the front side, are discharged through the sheet discharge port 113, and St1 to St13, which are the normal sheets on which the image has been printed on both sides, are discharged to the discharged sheet stacker 631 to prepare for the error recovery control.

### <Operation Based on Software Module of Image Forming Apparatus>

An operation based on the software module of the image forming apparatus 10 according to the first embodiment of the present invention will be described in detail.

The CPU 1001 monitors whether or not there is a misfed sheet among the sheets being conveyed by using the misfed sheet detector 3 while the comprehensive device controller 1 comprehensively controls each processing.

When the misfed sheet is detected by the misfed sheet detector 3, the CPU 1001 causes the misfed sheet detector 3 to immediately notify the head operation controller 2 of the detection, and causes the head operation controller 2 to retract the inkjet head 201 to the retraction position. When the misfed sheet is detected by the misfed sheet detector 3, the CPU 1001 causes the misfed sheet detector 3 to also notify the job manager 4 of the detection, and causes the job manager 4 to temporarily retract the print job data to prepare for the print job after the error recovery processing to be re-input. Further, the CPU 1001 causes the conveyance operation controller 5 to discharge the misfed sheet to the sheet discharge destination and discharge and retract the subsequent sheet that is the normal sheet to the sheet discharge destination corresponding to the printing state.

After the sheet retraction control is completed, the CPU 1001 causes the conveyance operation controller 5 to confirm whether or not there is a remaining sheet on the conveyance path. Then, the CPU 1001 causes the comprehensive device controller 1 to notify the job manager 4 of completion of the error recovery processing and instructs the job manager 4 to re-input the print job, thereby printing the image on the sheet again and ending the operation.

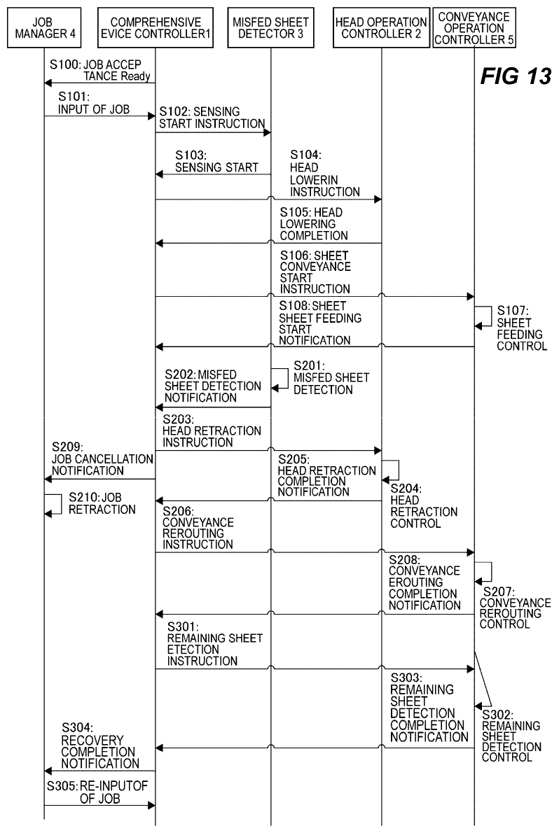

Next, the operation based on the software module of the image forming apparatus 10 will be described in more detail with reference to FIGS. 6 and 13.

The operation of the image forming apparatus 10 illustrated in FIG. 13 is started when the CPU 1001 reads and executes a program of the software module illustrated in FIG. 4, the program being stored in the HDD 1004.

First, the comprehensive device controller 1 notifies the job manager 4 that the print job can be accepted (transmits a message signal indicating “job acceptance Ready”) (S100).

Next, the job manager 4 inputs the print job to the comprehensive device controller 1 (S101).

Next, the comprehensive device controller 1 instructs the misfed sheet detector 3 to start sensing processing by the optical sensor 210 for detecting the misfed sheet (transmits a message signal of “sensing start instruction”) (S102).

Next, the misfed sheet detector 3 notifies the comprehensive device controller 1 that the sensing processing has been started (transmits a message signal of “sensing start”) (S103).

Next, the comprehensive device controller 1 instructs the head operation controller 2 to lower the inkjet head 201 to the printing position in order to print the image on the sheet (transmits a message signal of “head lowering instruction”) (S104).

Next, after lowering the inkjet head 201 to the printing position, the head operation controller 2 notifies the comprehensive device controller 1 of completion of the lowering (transmits a message signal of “head lowering completion”) (S105).

Next, the comprehensive device controller 1 instructs the conveyance operation controller 5 to start conveyance of the sheet (transmits a message signal of “sheet conveyance start instruction”) (S106).

Next, the conveyance operation controller 5 starts sheet feeding control to start sheet feeding from the first stage sheet feeding portion 100a, the second stage sheet feeding portion 100b, or the third stage sheet feeding portion 100c of the sheet feeding portion 100 (S107).

Next, the conveyance operation controller 5 notifies the comprehensive device controller 1 that sheet feeding has been started (transmits a message signal of “sheet feeding start notification”) (S108). As a result, the printing operation is started.

After starting the printing operation, the misfed sheet detector 3 detects the misfed sheet (S201).

Next, the misfed sheet detector 3 notifies the comprehensive device controller 1 that the misfed sheet has been detected (transmits a message signal of “misfed sheet detection notification”) (S202). As a result, the comprehensive device controller 1 starts the error recovery processing.

Next, the comprehensive device controller 1 instructs the head operation controller 2 to retract the inkjet head 201 from the printing position to the retraction position (transmits a message signal of “head retraction instruction”) (S203).

Next, the head operation controller 2 performs head retraction control of retracting the inkjet head 201 from the printing position to the retraction position (S204). At this time, in a case where both sides of the misfed sheet detected in S201 are blank, the head operation controller 2 returns the inkjet head 201 from the retraction position to the printing position after the misfed sheet passes through the printing portion 200. After printing the image on the normal sheet, the head operation controller 2 moves the inkjet head 201 from the printing position to the initial position.

Next, the head operation controller 2 notifies the comprehensive device controller 1 of completion of the retraction control for the inkjet head 201 (transmits a message signal of “head retraction completion notification”) (S205).

In addition, in the error recovery processing, the comprehensive device controller 1 instructs the conveyance operation controller 5 to reroute the subsequent sheet from the current conveyance path to the conveyance path to a temporary retraction destination (transmits a message signal of “conveyance rerouting instruction”) (S206).

Next, the conveyance operation controller 5 executes conveyance rerouting control processing of rerouting to discharge and temporarily retract the subsequent sheet (S207). At this time, in a case where both sides of the misfed sheet detected in S201 are blank, the conveyance operation controller 5 maintains the normal sheet discharge destination without changing the sheet discharge destination of the preceding sheet, which is the normal sheet on which the image has been printed only on the front side, and continues the conveyance processing.

Next, the conveyance operation controller 5 notifies the comprehensive device controller 1 of completion of the conveyance rerouting control processing after completing the discharge of all the preceding sheets and subsequent sheets to the retraction destination or the normal sheet discharge destination (transmits a message signal of “conveyance rerouting completion notification”) (S208).

Furthermore, in the error recovery processing, the comprehensive device controller 1 notifies the job manager 4 of job cancellation in order to retract the print job data (transmits a message signal of “job cancellation notification”) (S209).

Next, the job manager 4 retracts and holds the print job data as print data being printed (S210).

In the above operation, the operation of step S203, the operation of step S206, and the operation of step S209 by the comprehensive device controller 1 are performed in parallel.

Next, the comprehensive device controller 1 instructs the conveyance operation controller 5 to execute remaining sheet detection control processing for confirming whether or not there is a remaining sheet on the conveyance path (transmits a message signal of “remaining sheet detection instruction”) (S301).

Next, the conveyance operation controller 5 executes the remaining sheet detection control processing of confirming whether or not there is a remaining sheet on the conveyance path (S302).

Next, after the remaining sheet detection control processing is completed, the conveyance operation controller 5 notifies the comprehensive device controller 1 of completion of the remaining sheet detection control processing (transmits a message signal of “remaining sheet detection completion notification”) (S303).

Next, the comprehensive device controller 1 notifies the job manager 4 that the error recovery processing has been completed (transmits a message signal of “recovery completion notification”) (S304).

Next, the job manager 4 accepts the print job data being printed, re-inputs the print job data to the comprehensive device controller 1, and resumes the print job, the print job data being retracted and held in the processing of step S210 (S305). At this time, in a case where the image has been printed only on the front side of the misfed sheet detected in S201, the job manager 4 regenerates the print job data such that the image to be printed on the abnormal sheet is printed on the sheet newly conveyed by the conveying portion 700.

### <Operation of Hardware of Image Forming Apparatus>

An operation of hardware of the image forming apparatus 10 according to the first embodiment of the present invention will be described in detail.

The CPU 1001 starts the printing operation when the print job is received, and starts execution of the misfed sheet detection control processing for detecting the misfed sheet, the print head control processing for printing the image on the sheet, and the sheet conveyance control processing for conveying the sheet.

In a case where the misfed sheet has been detected during the printing operation, the CPU 1001 starts the error recovery processing, retracts the inkjet head 201 and the sheet being conveyed, and executes the conveyance rerouting control processing and the remaining sheet detection control processing. Thereafter, the CPU 1001 ends the printing operation in a case where the sheet discharge has been completed up to the last page, with no misfed sheet detected, after the re-input print job is received again and the error recovery processing ends. In addition, the CPU 1001 ends the misfed sheet detection control processing, the print head control processing, and the sheet conveyance control processing.

The sheet during the double-sided job is inspected by the optical sensor 210 as to whether or not the sheet is the misfed sheet, and then passes through the inkjet head 201, so that the image is printed on the front side. Further, the sheet on which the image has been printed on the front side is circulated on the conveyance path, conveyed again to the printing portion 200, inspected by the optical sensor 210 as to whether or not the sheet is the misfed sheet for the second time, and then passes through the inkjet head 201, so that the image is printed on the back side.

In a case where the misfed sheet on which the image is already printed is detected by the second inspection as to whether or not the sheet is the misfed sheet, the image printed on the misfed sheet is printed on the normal sheet by performing the bitmap shift in order to execute the error recovery processing. In this case, it is necessary to perform the re-conveyance control for arranging the page order. Therefore, in this case, after the inkjet head 201 is retracted and the misfed sheet is discharged, the conveyance control is performed such that the subsequent sheet is also temporarily retracted to the retraction destination different from the retraction destination of the misfed sheet to prepare for the subsequent error recovery control.

In addition, in a case where the misfed sheet on which the image has not been printed is detected by the first inspection as to whether or not the sheet is the misfed sheet, it is not necessary to perform re-printing of the image and re-conveyance control for arranging the page order. Therefore, in this case, after the inkjet head 201 is temporarily retracted to the retraction position, and the misfed sheet is discharged, the inkjet head 201 is returned to the printing position, and printing of the image on the preceding sheet is continued as it is.

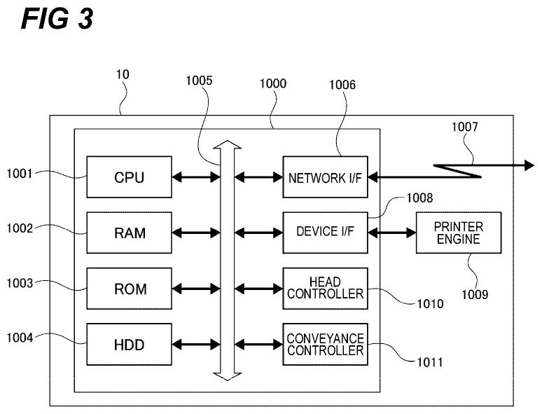

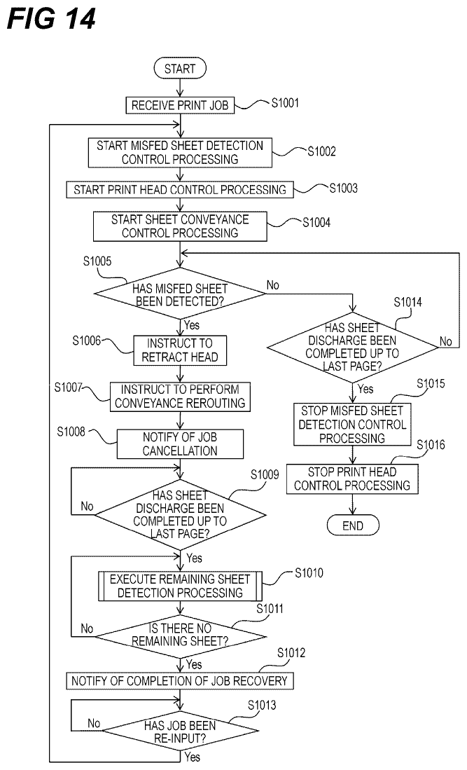

Next, the operation of hardware of the image forming apparatus 10 will be described in more detail with reference to FIGS. 3 and 14.

The operation illustrated in FIG. 14 is started at a timing when the CPU 1001 detects that the print job has been transmitted to the image forming apparatus 10.

First, the CPU 1001 receives the print job from the print server 70 via the local area network 1007 and the network I/F 1006, and stores and holds the print job data in the RAM 1002 (S1001).

Next, the CPU 1001 starts the misfed sheet detection control processing in order to monitor whether or not there is a misfed sheet among the sheets being conveyed according to the operation of step S102 of the operation illustrated in FIG. 13 (S1002). The misfed sheet detection control processing is described below.

Next, the CPU 1001 starts the print head control processing in order to eject the ink onto the sheet and perform printing (S1003). The print head control processing is described below.

Next, the CPU 1001 starts the sheet conveyance control processing in order to convey the sheet (S1004). The sheet conveyance control processing is described below.

Next, the CPU 1001 determines whether or not the misfed sheet has been detected based on the electric signal input from the optical sensor 210 in the misfed sheet detection control processing (S1005).

In a case where the misfed sheet has been detected (step S1005: Yes), the CPU 1001 instructs the inkjet head 201 to move to the retraction position according to the operation of step S203 of the operation illustrated in FIG. 13 (S1006).

Next, the CPU 1001 starts the error recovery control, and instructs to reroute the subsequent sheet to the conveyance path for conveying the preceding sheet and the subsequent sheet to the normal sheet discharge destination or retracting the preceding sheet and the subsequent sheet to the sheet discharge destination as the retraction destination according to the operation of step S206 of the operation illustrated in FIG. 13 (S1007).

Next, the CPU 1001 notifies the print server 70 of the job cancellation via the network I/F 1006 and retracts the print job data being printed according to the operation of step S209 of the operation illustrated in FIG. 13 (S1008).

Next, the CPU 1001 determines whether or not the discharge of the sheet being conveyed has been completed up to the last page (S1009).

In a case where the discharge of the sheet being conveyed has not been completed up to the last page (step S1009: No), the CPU 1001 repeats the processing of step S1009.

On the other hand, in a case where the discharge of the sheet being conveyed has been completed up to the last page (step S1009: Yes), the CPU 1001 executes the remaining sheet detection control processing according to the operation of step S301 of the operation of FIG. 13 (S1010). The remaining sheet detection control processing is described below.

Next, the CPU 1001 determines whether or not there is no remaining sheet (S1011).

In a case where there is a remaining sheet and a notification that the remaining sheet has been detected is received in the remaining sheet detection control processing (step S1011: No), the CPU 1001 notifies a user of remaining sheet information and urges the user to remove the remaining sheet. Thereafter, the CPU 1001 returns to the processing of step S1010.

On the other hand, in a case where there is no remaining sheet and the notification that there is no remaining sheet is received in the remaining sheet detection control processing (step S1011: Yes), the CPU 1001 urges the print server 70 to re-input the print job (S1012).

Next, the CPU 1001 determines whether or not the print job has been re-input from the print server 70 (S1013).

In a case where the print job has not been re-input (step S1012: No), the CPU 1001 repeats the processing of step S1012.

On the other hand, in a case where the print job has been re-input (step S1012: Yes), the CPU 1001 returns to the processing of step S1002.

In a case where the misfed sheet has not been detected in the processing of step S1005 (step S1005: No), the CPU 1001 determines whether or not the sheet discharge has been completed up to the last page (S1014).

In a case where the sheet discharge has not been completed up to the last page (step S1014: No), the CPU 1001 returns to the processing of step S1006.

On the other hand, in a case where the sheet discharge has been completed up to the last page (step S1014: Yes), the CPU 1001 instructs to stop the misfed sheet detection control processing (S1015).

Next, the CPU 1001 instructs to stop the print head control processing (S1016), and then ends the operation.

### <Misfed Sheet Detection Control Processing>

The misfed sheet detection control processing executed by the image forming apparatus 10 according to the first embodiment of the present invention will be described in detail.

The misfed sheet detection control processing is processing of detecting whether or not there is a misfed sheet among the sheets being conveyed by the conveying portion 700 by using the optical sensor 210 of the printing portion 200. In the misfed sheet detection control processing, monitoring of the misfed sheet is continued until an instruction to stop the processing is issued, and a message signal of a misfed sheet detection notification is immediately transmitted when the misfed sheet is detected.

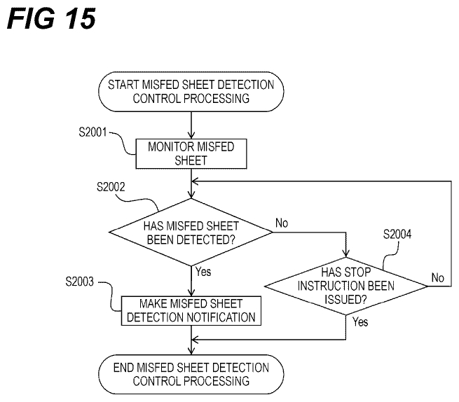

Next, the misfed sheet detection control processing will be described in more detail with reference to FIG. 15.

The misfed sheet detection control processing illustrated in FIG. 15 is started at a timing when the operation of step S1002 of the operation illustrated in FIG. 14 is started.

First, the CPU 1001 activates the optical sensor 210 in a case where the optical sensor 210 is not activated, and holds the optical sensor 210 in an activated state in a case where the optical sensor 210 is already activated. The CPU 1001 activates the optical sensor 210 to enable the optical sensor 210 to detect the misfed sheet, thereby performing the monitoring of the misfed sheet (S2001).

Next, the CPU 1001 determines whether or not the misfed sheet has been detected by the optical sensor 210 (S2002).

In a case where the misfed sheet has been detected (step S2002: Yes), the CPU 1001 makes the misfed sheet detection notification (S2003), and then ends the misfed sheet detection control processing.

On the other hand, in a case where the misfed sheet has not been detected by the optical sensor 210 (step S2002: No), the CPU 1001 determines whether or not an instruction to stop the misfed sheet detection control processing by the operation of step S1015 of the operation illustrated in FIG. 14 has been issued (S2004).

In a case where the stop instruction has not been issued (step S2004: No), the CPU 1001 returns to the processing of step S2002.

On the other hand, in a case where the stop instruction has been issued (step S2004: Yes), the CPU 1001 ends the misfed sheet detection control processing.

### <Print Head Control Processing>

The print head control processing executed by the image forming apparatus 10 according to the first embodiment of the present invention will be described in detail.

The print head control processing is processing of moving the inkjet head 201 to the printing position by the head controller 1010 when the printing operation starts, ejecting the ink onto the conveyed sheet from the inkjet head 201, and printing the image on the sheet. Furthermore, the print head control processing is processing of immediately moving and retracting the inkjet head 201 from the printing position to the retraction position by the head controller 1010 when the misfed sheet is detected in order to avoid the collision between the inkjet head 201 and the misfed sheet. The print head control processing is processing of returning the inkjet head 201 from the retraction position to the printing position when the misfed sheet passes through the printing portion 200 in the case of printing the image on the preceding sheet or subsequent sheet.

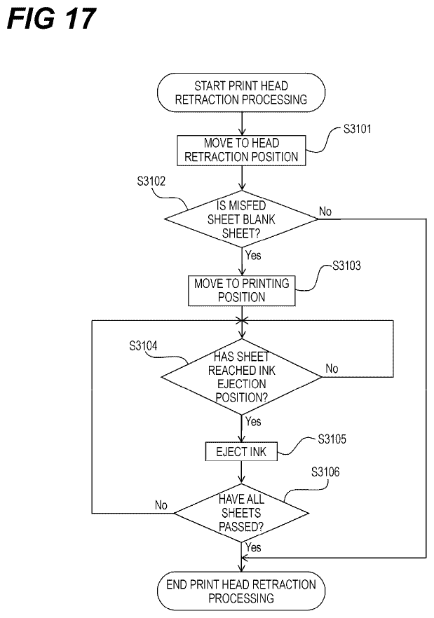

Next, the print head control processing will be described in more detail with reference to FIG. 17.

The print head control processing illustrated in FIG. 17 is started at a timing when the operation of step S1003 of the operation illustrated in FIG. 14 is started.

First, the CPU 1001 controls the head controller 1010 to move the inkjet head 201 to the printing position at which the ink can be ejected onto the sheet according to the operation of step S104 of the operation illustrated in FIG. 13 (S3001).

Next, the CPU 1001 determines whether or not an instruction to move the inkjet head 201 to the retraction position has been issued by the operation of step S1006 of the operation illustrated in FIG. 14 (S3002).

In a case where the instruction to move the inkjet head 201 to the retraction position has been issued (step S3002: Yes), the CPU 1001 controls the head controller 1010 to execute the print head retraction processing (S3003). The print head retraction processing is described below. Thereafter, the CPU 1001 ends the print head control processing

On the other hand, in a case where the instruction to move the inkjet head 201 to the retraction position has not been issued (step S3002: No), the CPU 1001 determines whether or not the sheet has reached an ink ejection position of the inkjet head 201 (S3004).

In a case where the sheet has not reached the ink ejection position (step S3004: No), the CPU 1001 returns to the processing of step S3002.

On the other hand, in a case where the sheet has reached the ink ejection position (step S3004: Yes), the CPU 1001 controls the head controller 1010 to cause the inkjet head 201 to eject the ink onto the sheet (S3005).

Next, the CPU 1001 determines whether or not an instruction to stop the print head control processing has been issued by the operation of step S1016 of the operation illustrated in FIG. 14 (S3006).

In a case where the instruction to stop the print head control processing has not been issued (step S3006: No), the CPU 1001 returns to the processing of step S3002.

On the other hand, in a case where the instruction to stop the print head control processing has been issued (step S3006: Yes), the CPU 1001 moves the inkjet head 201 to an initial position and ends the print head control processing.

### <Print Head Retraction Processing>

The print head retraction processing executed by the image forming apparatus 10 according to the first embodiment of the present invention will be described in detail.

The print head retraction processing is processing of immediately retracting the inkjet head 201 to the retraction position in order to avoid the collision between the inkjet head 201 and the misfed sheet in a case where the misfed sheet is detected.

At this time, in a case where the image has been printed on the front side of the misfed sheet, it is necessary to print the image printed on the front side of the misfed sheet again on the subsequent sheet which is the normal sheet and perform re-conveyance control so as to arrange the page order. Therefore, in a case where the image has been printed on the front side of the misfed sheet, the image cannot be continuously printed on the subsequent sheet.

On the other hand, in a case where no image has been printed on the misfed sheet, it is not necessary to execute processing of reprinting the image to be printed on the misfed sheet on the subsequent sheet and arranging the page order, and thus, the image can be continuously printed on the preceding sheet. As described above, in a case where an image can be continuously printed on the preceding sheet, it is desired to print the image on both sides of the preceding sheet and complete the sheet discharge.

Therefore, in the print head retraction processing, in a case where no image has been printed on the misfed sheet, the inkjet head 201 retracted to the retraction position is returned to the printing position, and printing of the image on the preceding sheet is continued.

Next, the print head retraction processing will be described in more detail with reference to FIG. 17.

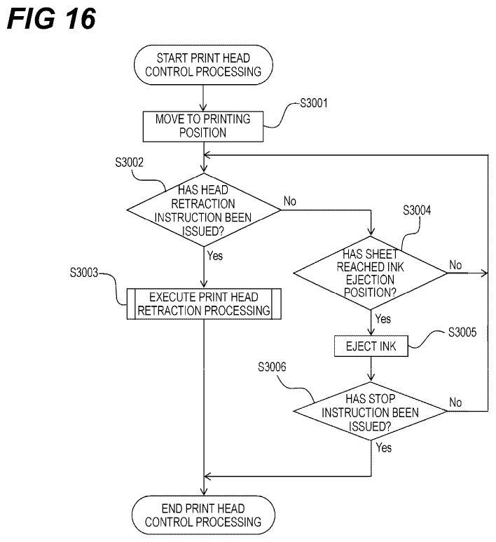

The print head retraction processing illustrated in FIG. 17 is started at a timing when an affirmative determination (Yes) is made in the processing of step S3002 of the print head control processing illustrated in FIG. 16.

First, in order to avoid the collision between the inkjet head 201 and the misfed sheet, the CPU 1001 controls the head controller 1010 to move the inkjet head 201 from the printing position to the retraction position and waits for the misfed sheet to pass (S3101).

Next, the CPU 1001 determines whether or not both sides of the misfed sheet are blank (S3102).

In a case where the image has been printed only on the front side of the misfed sheet (step S3102: No), the CPU 1001 ends the print head retraction processing.

On the other hand, in a case where both sides of the misfed sheet are blank (step S3102: Yes), the CPU 1001 moves the inkjet head 201 from the retraction position to the printing position after the misfed sheet passes through the inkjet head 201 (S3103).

Next, the CPU 1001 determines whether or not the preceding sheet has reached the ink ejection position (S3104).

In a case where the preceding sheet has not reached the ink ejection position (step S3104: No), the CPU 1001 repeats the processing of step S3104 and waits for the preceding sheet to reach the ink ejection position.

On the other hand, in a case where the preceding sheet has reached the ink ejection position (step S3104: Yes), the CPU 1001 controls the head controller 1010 to eject the ink onto the preceding sheet (S3105).

Next, the CPU 1001 determines whether or not all the sheets being conveyed have passed through the inkjet head 201 (S3106).

In a case where all the sheets being conveyed have passed through the inkjet head 201 (step S3106: Yes), the CPU 1001 ends the print head retraction processing.

On the other hand, in a case where not all the sheets being conveyed have passed through the inkjet head 201 (step S3106: No), the CPU 1001 returns to the processing of step S3104.

In the above-described print head retraction processing, whether or not both sides of the misfed sheet are blank and whether or not the image has been printed only on the front side can be determined based on an elapsed time from the sheet feeding start time of the misfed sheet to the passage of the misfed sheet through the inkjet head 201. Time information regarding a time required for the sheet to pass through the inkjet head 201 once from the sheet feeding start time and a time required for the sheet to pass through the inkjet head twice is stored in the ROM 1003 in advance.

### <Sheet Conveyance Control Processing>

The sheet conveyance control processing executed by the image forming apparatus 10 according to the first embodiment of the present invention will be described in detail.

The sheet conveyance control processing is processing of starting conveyance of the sheet fed from the sheet feeding portion 100 by rotating the conveying roller and executing the conveyance rerouting control processing in a case where an instruction to perform rerouting for changing the conveyance path due to detection of the misfed sheet is issued. Further, the sheet conveyance control processing is processing of notifying that the conveyance of all the sheets has been completed and stopping the conveying roller to end the conveyance of the sheet when the sheet discharge has been completed up to the sheet of the last page.

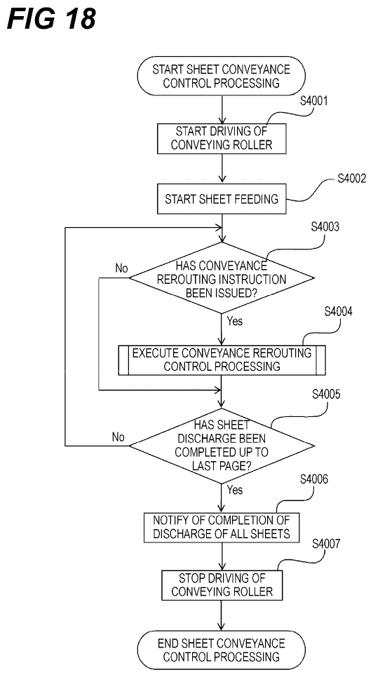

Next, the sheet conveyance control processing will be described in more detail with reference to FIG. 18.

The sheet conveyance control processing illustrated in FIG. 18 is started at a timing when the operation of step S1004 of the operation illustrated in FIG. 14 is started.

First, the CPU 1001 controls the conveyance controller 1011 to start driving of the conveying roller (S4001).

Next, the CPU 1001 controls the conveyance controller 1011 to cause the sheet feeding portion 100 to start sheet feeding (S4002).

Next, the CPU 1001 determines whether or not an instruction to reroute the subsequent sheet to the conveyance path for retracting the subsequent sheet to the sheet discharge destination has been issued by the operation of step S1007 of the operation illustrated in FIG. 14 (S4003).

In a case where the rerouting instruction has been issued (step S4003: Yes), the CPU 1001 executes the conveyance rerouting control processing (S4004). The conveyance rerouting control processing is described below.

Next, the CPU 1001 determines whether or not the sheet discharge has been completed up to the sheet of the last page (S4005).

In a case where the sheet discharge has not been completed up to the sheet of the last page (step S4005: No), the CPU 1001 returns to the processing of step S4003.

On the other hand, in a case where sheet discharge has been completed up to the sheet of the last page (step S4005: Yes), the CPU 1001 notifies that the discharge of all the sheets has been completed (S4006). Then, the CPU 1001 makes a conveyance rerouting completion notification by the operation of step S208 of the operation illustrated in FIG. 13 to notify that the conveyance rerouting control processing has been completed.

Next, the CPU 1001 controls the conveyance controller 1011 to stop the driving of the conveying roller (S4007), and then ends the sheet conveyance control processing.

On the other hand, in a case where the rerouting instruction has not been issued in step S4003 (step S4003: No), the CPU 1001 skips to the processing of step S4005.

### <Remaining Sheet Detection Control Processing>

The remaining sheet detection control processing executed by the image forming apparatus 10 according to the first embodiment of the present invention will be described in detail.

The remaining sheet detection control processing is processing for confirming whether or not an unexpected sheet remains on the conveyance path to confirm that the error recovery processing has been normally executed when the sheet being conveyed is retracted to the sheet discharge destination by the conveyance rerouting control processing caused by the detection of the misfed sheet. In the remaining sheet detection control processing, the conveying roller is driven for a predetermined time to confirm whether or not any of conveyance sensors has detected a sheet remaining on the conveyance path. In the remaining sheet detection control processing, in a case where a sheet has been detected by the conveyance sensor, it is notified that the remaining sheet has been detected, and in a case where no sheet has been detected by the conveyance sensor, it is notified that there is no remaining sheet.

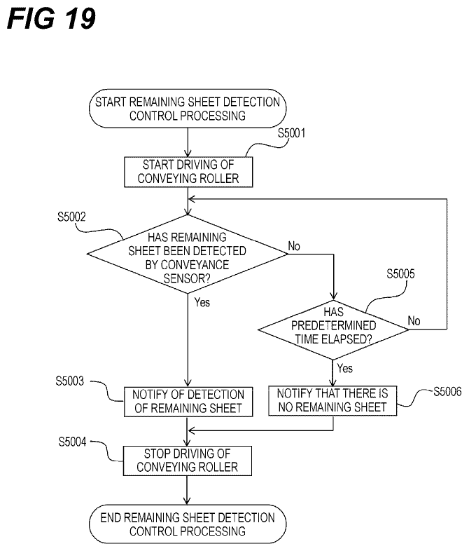

Next, the remaining sheet detection control processing will be described in more detail with reference to FIG. 19.

The remaining sheet detection control processing illustrated in FIG. 19 is started at a timing when an affirmative determination (Yes) is made in the operation of step S1009 of the operation illustrated in FIG. 14.

First, the CPU 1001 controls the conveyance controller 1011 to start driving of the conveying roller (S5001).

Next, the CPU 1001 determines whether or not a remaining sheet has been detected by the conveyance sensor (S5002).

In a case where a remaining sheet has been detected (step S5002: Yes), the CPU 1001 notifies that a remaining sheet has been detected (S5003).

Next, the CPU 1001 controls the conveyance controller 1011 to stop the driving of the conveying roller (S5004), and then ends the remaining sheet detection control processing.

On the other hand, in a case where remaining sheet has been not detected in step S5002 (step S5002: No), the CPU 1001 determines whether or not a predetermined time has elapsed from the detection of the misfed sheet (S5005).

In a case where the predetermined time has not elapsed (step S5005: No), the CPU 1001 returns to the processing of step S5002.

On the other hand, in a case where the predetermined time has elapsed (step S5005: Yes), the CPU 1001 notifies that there is no remaining sheet (S5006), and then executes the processing of step S5004.

After ending the remaining sheet detection control processing illustrated in FIG. 19, the CPU 1001 starts the operation of step S1011 of the operation illustrated in FIG. 14.

### <Conveyance Rerouting Control Processing>

The conveyance rerouting control processing executed by the image forming apparatus 10 according to the first embodiment of the present invention will be described in detail.

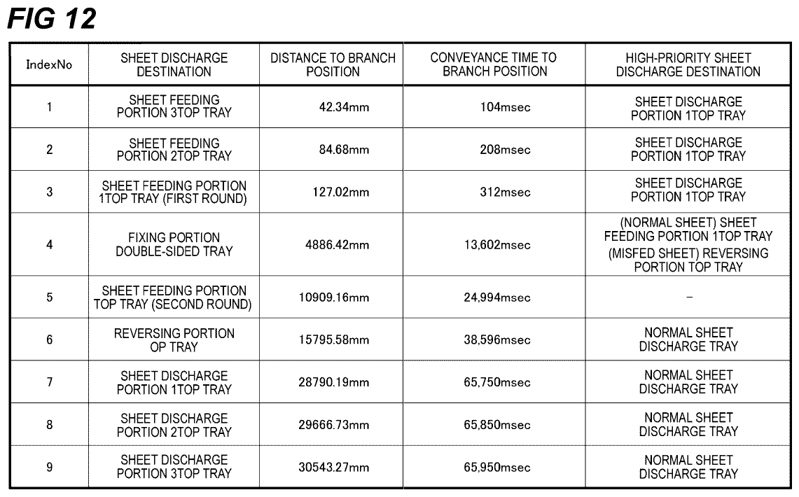

The conveyance rerouting control processing is processing of selecting and determining the sheet discharge destination according to a position where the sheet being conveyed is present on the conveyance path when the misfed sheet is detected, by using the sheet discharge destination management table illustrated as an example in FIG. 12. The conveyance rerouting control processing is processing of switching a conveyance destination so as to guide the sheet to a designated high-priority sheet discharge destination in a case where the high-priority sheet discharge destination is designated in the sheet discharge destination management table.

Here, the sheet discharge destination management table is a table that manages a plurality of sheet discharge destinations that can be used as the sheet retraction destinations when the misfed sheet is detected. The sheet discharge destination management table stores information of “IndexNo”, “sheet discharge destination”, “distance to branch position”, “conveyance time to branch position”, and “high-priority sheet discharge destination” in association with each other.

“IndexNo” is an identifier for uniquely identifying the sheet discharge destination. “Sheet discharge destination” indicates the sheet discharge destination. “Distance to branch position” indicates a distance to the branch position on the conveyance path for discharging the sheet to the associated sheet discharge destination with a sheet feeding position of the sheet feeding portion 100 as 0 mm. “Conveyance time to branch position” indicates a time required for movement to the branch position on the conveyance path for discharging the sheet to the associated sheet discharge destination at a predetermined conveyance speed with the sheet feeding start time from the sheet feeding portion 100 as 0 second.

In the sheet discharge destination management table illustrated in FIG. 12, a sheet feeding position Q (see FIG. 5) of the sheet feeding cassette 132 is 0 mm. Further, the branch position corresponding to the distance to the branch position and the conveyance time to the branch position of IndexNo. 1 is the branch position B1. The branch position corresponding to the distance to the branch position and the conveyance time to the branch position of IndexNo. 2 is the branch position B2. The branch position corresponding to the distances to the branch position and the conveyance times to the branch position of IndexNo. 3 and IndexNo. 5 is the branch position B3. The branch position corresponding to the distance to the branch position and the conveyance time to the branch position of IndexNo. 4 is the branch position B4.

The branch position corresponding to the distance to the branch position and the conveyance time to the branch position of IndexNo. 6 is the branch position B5. The branch position corresponding to the distance to the branch position and the conveyance time to the branch position of IndexNo. 7 is the branch position B6. The branch position corresponding to the distance to the branch position and the conveyance time to the branch position of IndexNo. 8 is the branch position B7. The branch position corresponding to the distance to the branch position and the conveyance time to the branch position of IndexNo. 9 is the branch position B8.

As for the sheet discharge destination of the sheet discharge destination management table, the sheet feeding portion 3TOP tray 134 is the sheet discharge destination of sheet discharge through the sheet discharge port 133, the sheet feeding portion 2TOP tray 124 is the sheet discharge destination of sheet discharge through the sheet discharge port 123, and the sheet feeding portion 1TOP tray 114 is the sheet discharge destination of sheet discharge through the sheet discharge port 113. Further, the fixing portion double-sided tray is the sheet discharge destination of sheet discharge through the sheet discharge port 301, and the reversing portion TOP tray 502 is the sheet discharge destination of sheet discharge through the sheet discharge port 501. Further, the sheet discharge portion 1TOP tray is the sheet discharge destination of sheet discharge through the sheet discharge port 612, the sheet discharge portion 2TOP tray is the sheet discharge destination of sheet discharge through the sheet discharge port 622, and the sheet discharge portion 3TOP tray is the sheet discharge destination of sheet discharge through the sheet discharge port 632.

In the sheet discharge destination management table illustrated in FIG. 12, the sheet discharge destination for the sheet present upstream of the sheet discharge portion 1TOP tray in the conveyance direction when the misfed sheet is detected is the sheet discharge portion 1TOP tray. In the sheet discharge destination management table illustrated in FIG. 12, the sheet discharge destination for the sheet present between the sheet discharge portion 1TOP tray and the sheet discharge portion 2TOP tray when the misfed sheet is detected is the sheet discharge portion 2TOP tray. Further, in the sheet discharge destination management table illustrated in FIG. 12, the sheet discharge destination for the sheet present between the sheet discharge portion 2TOP tray and the sheet discharge portion 3TOP tray when the misfed sheet is detected is the sheet discharge portion 3TOP tray.

On the other hand, in the sheet discharge destination management table illustrated in FIG. 12, the high-priority sheet discharge destination for the sheet being conveyed between the sheet feeding cassette 132 and the branch position B3 to the sheet discharge portion 1TOP tray when the misfed sheet is detected is the sheet discharge portion 1TOP tray. As a result, the image forming apparatus 10 can collectively discharge, to the same sheet discharge portion 1TOP tray, the sheets being conveyed between the sheet feeding cassette 132 and the branch position B3 to the sheet discharge portion 1TOP tray.

Further, in the sheet discharge destination management table illustrated in FIG. 12, the fixing portion double-sided tray is set as the sheet discharge destination of the sheet present in a range between the branch position B3 to the sheet discharge portion 1TOP tray and the branch position B4 to the fixing portion double-sided tray when the misfed sheet is detected. However, the misfed sheet and the normal sheet present in the range between the branch position B3 to the sheet discharge portion 1TOP tray and the branch position B4 to the fixing portion double-sided tray are desirably discharged to different sheet discharge destinations. Therefore, in the sheet discharge destination management table illustrated in FIG. 12, the high-priority sheet discharge destination of the misfed sheet present in the range between the branch position B3 to the sheet discharge portion 1TOP tray and the branch position B4 to the fixing portion double-sided tray is set to the reversing portion TOP tray 502.

In the sheet discharge destination management table illustrated in FIG. 12, the high-priority sheet discharge destination of the normal sheet present in the range between the branch position B3 to the sheet discharge portion 1TOP tray and the branch position B4 to the fixing portion double-sided tray is set to the sheet feeding portion 1TOP tray 114.

Since the normal sheet present in the range between the branch position B3 to the sheet discharge portion 1TOP tray and the branch position B4 to the fixing portion double-sided tray has passed through the printing portion 200 once, the image is printed only on the front side. The sheet on which the image has been printed only on the front side other than the normal sheet present in the range between the branch position B3 to the sheet discharge portion 1TOP tray and the branch position B4 to the fixing portion double-sided tray is also present downstream of the branch position B4 to the fixing portion double-sided tray in the conveyance direction. In the sheet discharge destination management table illustrated in FIG. 12, the high-priority sheet discharge destination of the normal sheet on which the image has been printed only on the front side and which is present downstream of the branch position B4 in the conveyance direction is set to the same sheet feeding portion 1TOP tray 114 as that for the normal sheet present upstream of the branch position B4 in the conveyance direction.

Only the normal sheet on which the image has been printed on both sides (having both sides printed) is present downstream of the branch position B3 to the sheet feeding portion 1TOP tray 114 in the second round in the conveyance direction. Therefore, there is no problem even if the normal sheet present downstream of the branch position B3 to the sheet feeding portion 1TOP tray 114 in the second round in the conveyance direction is discharged as usual, and it is not necessary to switch the sheet discharge destination. Accordingly, in the sheet discharge destination management table illustrated in FIG. 12, the high-priority sheet discharge destination of the normal sheet present downstream of the branch position B3 to the sheet feeding portion 1TOP tray 114 in the second round in the conveyance direction is set to a normal sheet discharge tray. Here, the normal sheet discharge tray is the discharged sheet stacker 611, the discharged sheet stacker 621, or the discharged sheet stacker 631.

The sheet discharge destination management table is set and stored in advance for each of the sheet feeding cassettes 110 to 112, 120 to 122, and 130 to 132. In the present embodiment, a description of an example of the sheet discharge destination management table set corresponding to each of the sheet feeding cassettes 110 to 112, 120 to 122, 130, and 131 other than the sheet feeding cassette 132 is omitted.

In the conveyance rerouting control processing, the subsequent sheet is rerouted in a case where the image has been printed on the misfed sheet, and the preceding sheet is discharged to the normal sheet discharge destination without rerouting the preceding sheet in a case where the image has not been printed on both sides of the misfed sheet. In addition, in the conveyance rerouting control processing, rerouting of the subsequent sheet is performed and the subsequent sheet is discharged and retracted to the sheet discharge destination different from the sheet discharge destination of the misfed sheet in a case where the image has not been printed on both sides of the subsequent sheet that is a sheet discharge control target even in a case where the image has not been printed on both sides of the misfed sheet. The conveyance rerouting control processing is not limited to such processing, and in a case where the image has not been printed on both sides of the subsequent sheet that is the sheet discharge control target, the subsequent sheet may be normally conveyed as it is without being retracted, and discharged to the normal sheet discharge destination.

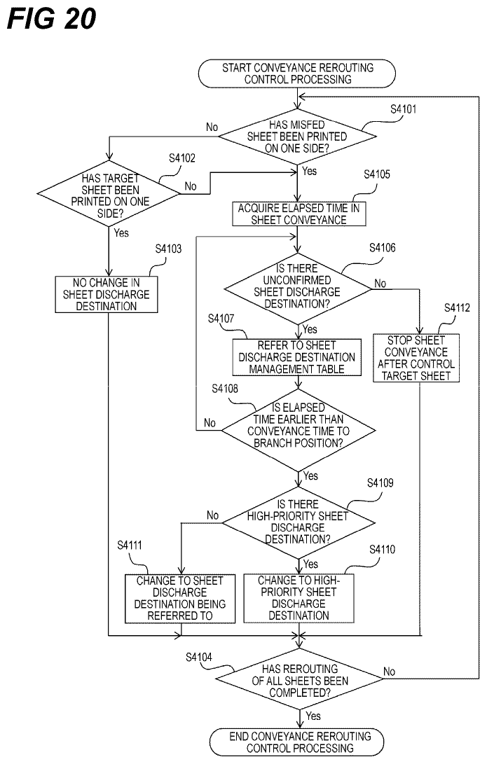

Next, the conveyance rerouting control processing will be described in more detail with reference to FIGS. 12 and 20.

The conveyance rerouting control processing illustrated in FIG. 20 is started at a timing when an affirmative determination (Yes) is made in the processing of step S4003 of the sheet conveyance control processing illustrated in FIG. 18.

First, the CPU 1001 determines whether or not the image has been printed only on the front side of the misfed sheet (the misfed sheet has been printed on one side) (S4101).

In a case where both sides of the misfed sheet are blank (step S4101: No), the CPU 1001 determines whether or not the image has been printed only on the front side of the preceding sheet that is the sheet discharge control target (the preceding sheet has been printed on one side) (S4102).

In a case where the image has been printed only on the front side of the preceding sheet that is the sheet discharge control target (step S: 4102: Yes), the CPU 1001 determines that there is no change in sheet discharge destination of the preceding sheet that is the sheet discharge control target (S4103).

Next, the CPU 1001 determines whether rerouting of all the sheets being conveyed has been completed (S4104).

In a case where the rerouting of all the sheets being conveyed has been completed (step S4104: Yes), the CPU 1001 ends the conveyance rerouting control processing.

On the other hand, in a case where the rerouting of all the sheets being conveyed has not been completed (step S4104: No), the CPU 1001 returns to the processing of step S4101.

In addition, in a case where the image has been printed only on the front side of the misfed sheet (step S4101: Yes), the CPU 1001 acquires an elapsed time from the sheet feeding start time of the preceding sheet and the subsequent sheet that are the sheet discharge control targets to the current time (S4105). The elapsed time from the sheet feeding start time to the current time is hereinafter referred to as the “elapsed time from the sheet feeding start time”.

Next, the CPU 1001 determines whether or not there is a sheet discharge destination that is not referred to in the sheet discharge destination management table (S4106). At this time, the CPU 1001 determines whether or not there is a sheet discharge destination that is not referred to in order from IndexNo. 1.

In a case where there is a sheet discharge destination that is not referred to (step S4106: Yes), the CPU 1001 refers to the sheet discharge destination that is not referred to in the sheet discharge destination management table (S4107).

Next, the CPU 1001 compares the elapsed time from the sheet feeding start time acquired in step S4105 with “conveyance time to branch position” being referred to in the sheet discharge destination management table. Then, the CPU 1001 determines whether or not the elapsed time from the sheet feeding start time acquired in step S4105 is earlier than “conveyance time to branch position” being referred to (S4108). In this manner, the CPU 1001 determines a position of the sheet that is the sheet discharge control target by using the elapsed time from the sheet feeding start time.

In a case where the acquired elapsed time from the sheet feeding start time is after “conveyance time to branch position” being referred to (step S4108: No), the CPU 1001 advances IndexNo that is being referred to in the sheet discharge destination management table by one, and returns to the processing of step S4106.

On the other hand, in a case where the acquired elapsed time from the sheet feeding start time is earlier than “conveyance time to branch position” being referred to (step S4108: Yes), the CPU 1001 determines whether or not the high-priority sheet discharge destination is associated with the sheet discharge destination being referred to (S4109).

In a case where the high-priority sheet discharge destination is associated with the sheet discharge destination associated with IndexNo being referred to (step S4109: Yes), the CPU 1001 changes the conveyance path such that the sheet that is the sheet discharge control target is discharged to the associated high-priority sheet discharge destination (S4110). Thereafter, the CPU 1001 proceeds to the processing of step S4104.

For example, in a case where IndexNo. 3 is referred to, the CPU 1001 changes the conveyance path such that the sheet that is the sheet discharge control target is discharged to the “sheet discharge portion 1TOP tray” that is the high-priority sheet discharge destination associated with IndexNo. 3. As described above, in a case where the sheet can be discharged to the high-priority sheet discharge destination, the CPU 1001 discharges the sheet that is the sheet discharge control target to the associated high-priority sheet discharge destination.

Here, the high-priority sheet discharge destination is the sheet discharge destination that has a short downtime at the time of completion of sheet discharge and is designated for collective sheet discharge for each printing state in which the sheet that is the sheet discharge control target is the misfed sheet, the normal sheet whose both sides are blank, or the normal sheet on which the image has been printed only on the front side.

As described above, the CPU 1001 uses the sheet discharge destination management table when executing the conveyance rerouting control processing to select the sheet discharge destination of the preceding sheet and the subsequent sheet according to the printing state of the misfed sheet. As a result, it is possible to calculate the sheet discharge destination to be selected as the sheet discharge destination according to a position of the sheet that is the sheet discharge control target on the conveyance path when the misfed sheet is detected.

In addition, in a case where the high-priority sheet discharge destination is not associated with the sheet discharge destination being referred to in the processing of step S4109 (step S4109: No), the CPU 1001 changes the conveyance path such that the preceding sheet and the subsequent sheet that are the sheet discharge control targets are discharged to the sheet discharge destination being referred to (S4111). Thereafter, the CPU 1001 executes the processing of step S4104. As a result, the CPU 1001 discharges the preceding sheet and the subsequent sheet present within a predetermined range specified by the elapsed time from the sheet feeding start time when the misfed sheet is detected to the closest sheet discharge destination positioned downstream of the predetermined range in the conveyance direction by using the sheet discharge destination management table.

In a case where there is no sheet discharge destination that is not referred to in the processing of step S4106 (step S4106: No), the CPU 1001 determines that there is no sheet discharge destination and stops sheet conveyance (S4112). A case where there is no sheet discharge destination that is not referred to means a case where the sheet has passed through the branch positions to all the sheet discharge destinations. Thereafter, the CPU 1001 executes the processing of step S4104.

By executing the conveyance rerouting control processing, it is possible to select the sheet discharge destination closest to the sheet being conveyed based on the elapsed time from the sheet feeding start time of the sheet being conveyed when the misfed sheet is detected. In addition, by referring to the sheet discharge destination management table, it is possible to implement control to switch the sheet discharge destination including the sheet discharge destination to be preferentially selected as the temporary retraction destination of the sheet being conveyed according to the position where the sheet that is the sheet discharge control target is present when the misfed sheet is detected.

In the processing of step S4102 of the conveyance rerouting control processing described above, in a case where both sides of the subsequent sheet that is the sheet discharge control target are blank, the subsequent sheet whose both sides are blank is temporarily retracted to the sheet discharge destination. However, the present invention is not limited thereto, and in the processing of step S4102, in a case where both sides of the subsequent sheet that is the sheet discharge control target are blank, conveyance of the subsequent sheet whose both sides are blank may be continued. In this case, the image is printed on both sides of the subsequent sheet whose both sides are blank, and the subsequent sheet printed both sides is discharged to the normal sheet discharge destination.

As described above, in a case where the misfed sheet on which the image has not been printed is detected, the inkjet head 201 is retracted to the retraction position and then returned to the printing position, printing of the image on the preceding sheet is resumed, and the preceding sheet is discharged to the normal sheet discharge destination to execute the error recovery processing. By executing such processing, the downtime may be shortened.

In the present embodiment, in a case where the image has not been printed on the misfed sheet, conveyance of the preceding sheets is continued, and the preceding sheets on which the image has been printed on both sides by the printing portion 200 are discharged to the discharged sheet stackers 611, 621, and 631. As a result, by discharging the preceding sheet in consideration of a case where the image has been printed on the abnormal sheet and a case where the image has not been printed on the abnormal sheet, it is possible to reduce the downtime for discharging the preceding sheet.

### Second Embodiment

A configuration of an image forming apparatus according to a second embodiment of the present invention is the same as those in FIGS. 1 and 2, and thus a description thereof will be omitted. In addition, since an operation based on software of the image forming apparatus according to the present embodiment is the same as the operation illustrated in FIG. 13, a description thereof will be omitted. Furthermore, since an operation other than conveyance rerouting control processing in an operation of hardware of the image forming apparatus according to the present embodiment is the same as that in FIG. 14, a description of the operation other than the conveyance rerouting control processing will be omitted.

### <Conveyance Rerouting Control Processing>

The conveyance rerouting control processing executed by the image forming apparatus according to the second embodiment of the present invention will be described in detail.

The conveyance rerouting control processing according to the present embodiment is processing of determining a printing state of a sheet according to the number of times the sheet that is a sheet discharge control target has passed through a printing portion 200, and dynamically determining a sheet discharge destination according to the determined printing state. In the conveyance rerouting control processing according to the present embodiment, processing corresponding to the printing state of the misfed sheet is executed, and the sheet discharge destination to be preferentially selected is dynamically determined according to positions of the preceding sheet and the subsequent sheet that are the sheet discharge control targets when the misfed sheet is detected.

In the conveyance rerouting control processing, the misfed sheet is discharged to a specific sheet discharge destination. In addition, the number of times the sheet has passed through the printing portion 200 is determined by comparing an elapsed time from a sheet feeding start time of the sheet that is the sheet discharge control target with a time required for the sheet to pass through the printing portion 200 once from the sheet feeding start time and a time required for the sheet to pass through the printing portion 200 twice. At this time, time information regarding the time required for the sheet to pass through the printing portion 200 once from the sheet feeding start time and the time required for the sheet to pass through the printing portion twice is stored in a ROM 1003 in advance. As a result, a position of the sheet that is the sheet discharge control target can be estimated from the elapsed time from the sheet feeding start time.

Specifically, in a case where the elapsed time from the sheet feeding start time of the sheet that is the sheet discharge control target is equal to or shorter than the time required for the sheet to pass through the printing portion 200 once, the number of times the sheet has passed through the printing portion 200 is determined to be 0 times. In addition, in a case where the elapsed time from the sheet feeding start time of the sheet that is the sheet discharge control target is longer than the time required for the sheet to pass through the printing portion 200 once and is equal to or shorter than the time required for the sheet to pass through the printing portion 200 twice, the number of times the sheet has passed through the printing portion 200 is determined to be one time. Furthermore, in a case where the elapsed time from the sheet feeding start time of the sheet that is the sheet discharge control target is longer than the time required for the sheet to pass through the printing portion 200 twice, the number of times the sheet has passed through the printing portion 200 is determined to be two times.

Further, the sheet discharge destination with the shortest downtime is selected according to the position of the sheet that is the sheet discharge control target. Specifically, the misfed sheet is discharged to a reversing portion TOP tray 502, and a normal sheet that has passed through the printing portion 200 0 times is discharged to a sheet discharge portion 1TOP tray positioned at the closest position. In addition, the normal sheet that has passed through the printing portion 200 once is discharged to a sheet feeding portion 1TOP tray 114 positioned at the closest position, and the normal sheet that has passed through the printing portion 200 twice is discharged to a normal sheet discharge destination.

The sheet discharge destination is not limited to the above, and can be changed to the sheet discharge destination from which a user can easily reuse the retracted normal sheet according to a conveyance path configuration of an image forming apparatus 10 such as a configuration additionally including an inspection machine or a finisher. Depending on the configuration of the apparatus, the sheet discharge destination may be switched for each process such as an image forming process, a fixing process, a cooling process, and a reversing process for the sheet.

Furthermore, the preceding sheet is discharged to the retraction destination without printing the image or is discharged to the normal sheet discharge destination while printing of the image is continued according to whether or not the preceding sheet is the misfed sheet on which the image has been printed only on the front side and which has passed through the printing portion 200 once. In addition, the subsequent sheet whose both sides are blank and which has passed through the printing portion 200 0 times is discharged to the retraction destination without switching the sheet discharge destination according to the printing state of the misfed sheet. The subsequent sheet whose both sides are blank is not limited to being discharged to the retraction destination without switching the sheet discharge destination, and whether to discharge the subsequent sheet to the retraction destination or to the normal sheet discharge destination may be determined depending on whether or not the subsequent sheet is the misfed sheet on which the image has been printed only on the front side.

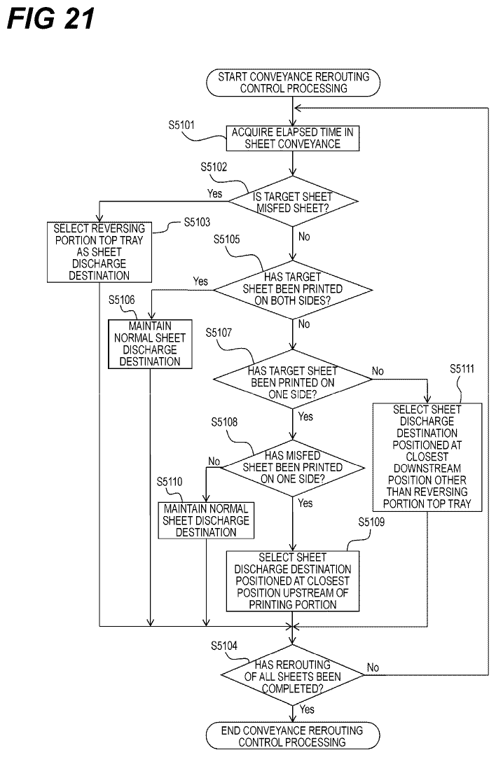

Subsequently, the conveyance rerouting control processing according to the present embodiment will be described in more detail with reference to FIG. 21.

The conveyance rerouting control processing illustrated in FIG. 21 is started at a timing when an affirmative determination (Yes) is made in the processing of step S4003 of the sheet conveyance control processing illustrated in FIG. 18.

First, a CPU 1001 acquires the elapsed time from the sheet feeding start time (S5101).

Next, the CPU 1001 determines whether or not the sheet that is the sheet discharge control target is the misfed sheet (S5102).

In a case where the sheet is the misfed sheet (step S5102: Yes), the CPU 1001 controls a conveyance controller 1011 to change a conveyance path such that the misfed sheet is discharged to the reversing portion TOP tray 502 (S5103).

Next, the CPU 1001 determines whether or not rerouting of all the sheets being conveyed has been completed (S5104).

In a case where the rerouting of all the sheets being conveyed has been completed (S5104: Yes), the CPU 1001 ends the conveyance rerouting control processing.

On the other hand, in a case where the rerouting of all the sheets being conveyed has not been completed (step S5104: No), the CPU 1001 returns to the processing of step S5101.

In addition, in a case where the sheet is not the misfed sheet in the processing of step S5102 (step S5102: No), the CPU 1001 determines whether or not the image has been printed on both sides of the sheet that is the sheet discharge control target (the sheet has been printed on both sides) (S5105).

In this case, the CPU 1001 determines whether or not the elapsed time from the sheet feeding start time of the sheet that is the sheet discharge control target acquired in the processing of step S5101 is longer than the time required for the sheet to pass through the printing portion 200 twice.

In a case where the image has been printed on both sides of the sheet that is the sheet discharge control target (step S5105: Yes), the CPU 1001 selects a sheet discharge port through which the sheet is to be discharged to the normal sheet discharge destination (S5106).

In this case, the CPU 1001 determines that the image has been printed on both sides of the sheet that is the sheet discharge control target based on the longer elapsed time from the sheet feeding start time of the sheet that is the sheet discharge control target than the time required for the sheet to pass through the printing portion 200 twice. Thereafter, the CPU 1001 executes the processing of step S5104.

In a case where the image has not been printed on both sides of the sheet that is the sheet discharge control target (step S5105: No), the CPU 1001 determines whether or not the image has been printed only on the front side of the sheet that is the sheet discharge control target (the sheet has been printed on one side) (S5107).

In this case, the CPU 1001 determines that the image has not been printed on both sides of the sheet that is the sheet discharge control target based on the elapsed time from the sheet feeding start time of the sheet that is the sheet discharge control target, the elapsed time being equal to or shorter than the time required for the sheet to pass through the printing portion 200 twice. In addition, the CPU 1001 determines whether or not the image has been printed only on the front side of the sheet that is the sheet discharge control target by determining whether or not the elapsed time from the sheet feeding start time of the sheet that is the sheet discharge control target is longer than the time required for the sheet to pass through the printing portion 200 once.

In a case where the image has been printed only on the front side of the sheet that is the sheet discharge control target (step S5107: Yes), the CPU 1001 determines whether or not the image has been printed only on the front side of the misfed sheet (the misfed sheet has been printed on one side) (S5108).

In this case, the CPU 1001 determines that the image has been printed only on the front side of the sheet that is the sheet discharge control target based on the longer elapsed time from the sheet feeding start time of the sheet that is the sheet discharge control target than the time required for the sheet to pass through the printing portion 200 once. In addition, the CPU 1001 determines whether or not the image has been printed only on the front side of the misfed sheet by determining whether or not the elapsed time from the sheet feeding start time of the misfed sheet is longer than the time required for the sheet to pass through the printing portion 200 once.

In a case where the image has been printed only on the front side of the misfed sheet (step S5108: Yes), the CPU 1001 changes the conveyance path such that the sheet that is the sheet discharge control target is discharged to the sheet discharge destination positioned at the closest position that is upstream of the printing portion 200 in the conveyance direction (S5109).

In this case, the CPU 1001 determines that the image has been printed only on the front side of the misfed sheet based on the longer elapsed time from the sheet feeding start time of the misfed sheet than the time required for the sheet to pass through the printing portion 200 once. Furthermore, the sheet discharge destination positioned at the closest position in this case is the sheet discharge destination positioned at the closest position that is upstream of the printing portion 200 in the conveyance direction and downstream of the position of the sheet that is the sheet discharge control target when the misfed sheet is detected in the conveyance direction, and is, for example, the sheet feeding portion 1TOP tray 114. Thereafter, the CPU 1001 executes the processing of step S5104.

On the other hand, in a case where both sides of the misfed sheet are blank (step S5108: No), the CPU 1001 does not change the sheet discharge destination of the sheet that is the sheet discharge control target and maintains the normal sheet discharge destination (S5110).

In this case, the CPU 1001 determines that both sides of the misfed sheet are blank based on the elapsed time from the sheet feeding start time of the misfed sheet, the elapsed time being equal to or shorter than the time required for the sheet to pass through the printing portion 200 once. Thereafter, the CPU 1001 executes the processing of step S5104.

In a case where both sides of the sheet that is the sheet discharge control target are blank (step S5107: No), the CPU 1001 changes the conveyance path such that the sheet that is the sheet discharge control target is discharged to the sheet discharge destination positioned at the closest downstream position in the conveyance direction other than the reversing portion TOP tray 502 (S5111).

In this case, the CPU 1001 determines that both sides of the sheet that is the sheet discharge control target are blank based on the fact that the image has not been printed on both sides of the sheet that is the sheet discharge control target and the image has not been printed only on the front side. In addition, the sheet discharge destination positioned at the closest position in this case is the sheet discharge destination positioned at the closest position that is downstream of the position of the sheet that is the sheet discharge control target when the misfed sheet is detected in the conveyance direction, and is, for example, the sheet feeding portion 1TOP tray 114. Thereafter, the CPU 1001 executes the processing of step S5104.

As described above, control of dynamically switching the sheet discharge destination according to the position where the sheet that is the control target is present is implemented by executing the conveyance rerouting control processing according to the printing state of the misfed sheet.

In the present embodiment, a blank state, a single-sided printing state, or a double-sided printing state is determined based on the number of times the conveyed sheet has passed through the printing portion 200. As a result, in the present embodiment, the effects of the first embodiment described above can be achieved, and a sheet discharge destination management table can be made unnecessary, and a simple configuration can be achieved.

It goes without saying that the present invention is not limited to the above-described embodiments, and various modifications can be made without departing from the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207615, filed Dec. 8, 2023, which is hereby incorporated by reference herein in its entirety.

What is claimed is:

1. An inkjet recording apparatus comprising:
a conveying portion configured to convey a sheet;
an ink head portion configured to eject ink onto the sheet conveyed by the conveying portion to form an image;
a detector provided upstream of the ink head portion in a conveyance direction of the sheet and configured to detect the sheet conveyed by the conveying portion;
a first stack tray provided downstream of the ink head portion in the conveyance direction and on which the sheet conveyed by the conveying portion is stacked;
a first conveyance path provided upstream of the first stack tray in the conveyance direction and through which the sheet conveyed by the conveying portion passes;
a second stack tray provided downstream of the ink head portion in the conveyance direction and on which the sheet conveyed by the conveying portion is stacked;
a second conveyance path branched from a portion of the first conveyance path that is downstream of the ink head portion and upstream of the first stack tray in the conveyance direction and through which the sheet on which the image has been formed on a first side by the ink head portion passes by being conveyed by the conveying portion to form the image on a second side opposite to the first side; and
a controller configured to control the conveying portion such that the sheet detected by the detector passes through the ink head portion without forming the image and is discharged to the first stack tray, and control the conveying portion such that a sheet which precedes the sheet detected by the detector, on which the image has been formed on the first side, and which is positioned on the second conveyance path to form the image on the second side passes through the ink head portion to form the image and is discharged to the second stack tray, in a case where the sheet conveyed by the conveying portion is detected by the detector.

2. The inkjet recording apparatus according to claim 1, wherein the detector detects uplift or a fold of the sheet.

3. The inkjet recording apparatus according to claim 1, further comprising a third stack tray provided upstream of the detector in the conveyance direction and on which the sheet conveyed by the conveying portion is stacked,
wherein the controller controls the conveying portion such that a subsequent sheet following the sheet detected by the detector is discharged to the third stack tray in a case where the sheet conveyed by the conveying portion is detected by the detector.

4. The inkjet recording apparatus according to claim 1, wherein the controller controls the conveying portion such that the sheet on which the image has been formed on the first side, which precedes the sheet which is detected by the detector and on which the image has not been formed on the first side and the second side, and which is positioned on the second conveyance path to form the image on the second side passes through the ink head portion to form the image and is discharged to the second stack tray.
